(19) United States
(12) Patent Application Publication
(10) Pub. No.: US 2004/0017392 A1
(43) Pub. Date: Jan. 29, 2004

(54) Web service control for use in a graphical programming environment

(76) Inventor: Keith C. Welch, Harwich, MA (US)

Correspondence Address: CESARI AND MCKENNA, LLP, 88 BLACK FALCON AVENUE, BOSTON, MA, 02210, US

(21) Appl. No.: 10/426,499

(22) Filed: Apr. 30, 2003

Related U.S. Application Data
(60) Provisional application No. 60/376,738, filed on May 1, 2002.

(51) Int. Cl. G09G 5/00

(52) U.S. Cl. 345/738

(57) ABSTRACT

A web service program object is provided for use in developing application programs through a graphical program-development environment. The web service program object has a corresponding icon that can be placed within a graphical program representation and visually coupled to other program objects to define the logical operation of a desired application program. The web service program object has a plurality of publicly declared properties that may be set by the program developer to specify the Uniform Resource Locator (URL) of a selected web service and a given method of the selected web service. At run-time, the web service program object causes a proxy class to be created for accessing the web service. The web service program object in cooperation with the proxy class receives one or more input parameter values from the program user, provides those values to the selected web service and receives responding information from the web service. Depending on the manner in which the application program was created, the responding information from the web service can be handled in any number of ways, such as being displayed to the program user or stored for later processing.

### CROSS-REFERENCE TO RELATED APPLICATIONS

The present application claims the benefit of U.S. Provisional Patent Application Serial No. 60/376,738, which was filed on May 1, 2002, by Keith Welch for a Web Service Program Object for use in a Graphical Programming Environment and is incorporated by reference herein in its entirety.

The present application is related to the following U.S. Patent Applications:

U.S. patent application Ser. No. 09/483,760 entitled, METHOD AND APPARATUS FOR RESOLVING DIVERGENT PATHS IN GRAPHICAL PROGRAMMING ENVIRONMENTS, filed Jan. 14, 2000, now U.S. Pat. No. 6,425,121; and

U.S. patent application Ser. No. 09/483,122 entitled, REPEATING PROGRAM OBJECT FOR USE WITH A GRAPHICAL PROGRAM-DEVELOPMENT SYSTEM, filed Jan. 14, 2000, now U.S. Pat. No. 6,425,120,

which are hereby incorporated by reference in their entireties.

### BACKGROUND OF THE INVENTION

1. Field of the Invention

The present invention relates generally to the field of computer programming and, more specifically, to software development environments.

2. Background Information

To generate a software program that can be executed or run by a computer, a software developer or programmer typically chooses a programming language, such as BASIC (Beginner's All-purpose Symbolic Instruction Code), Fortran, C, etc., and writes source code using the keywords, syntax, variable names, data structures, etc. defined by the selected programming language. Each programming language typically defines its own unique syntax and keywords for performing various functions. After the source code has been written, it is typically converted by a compiler into a machine readable format that can be understood by the computer (e.g., object code). If the developer used incorrect keywords or syntax, the source code cannot by compiled successfully.

The source code is typically written with a text editor and organized into a series of lines of code. Although simple programs may only need a few lines of code, complex programs often consume hundreds, thousands or tens of thousands of lines of code. Significant portions of code, moreover, are often required just to generate displayable user interface images or forms, such as text boxes, command buttons, etc. that can be displayed by windows-based computer systems, such as personal computers running the Microsoft Windows® series of operating systems from Microsoft Corporation of Redmond, Wash. Furthermore, significant editing is often required to make even relatively minor adjustments to such user interface elements (e.g., moving, re-sizing, etc.). In order to simplify the creation of such user interface images or forms, Microsoft developed and released a programming system known as Visual Basic®. Visual Basic includes a language engine for executing text-based programming statements, and a forms layout package having a plurality of objects or icons representing common user interface elements, such as text boxes, radio buttons, command buttons, scroll bars, etc. When a developer selects one of these objects from a tool palette and places it onto a form window, Visual Basic automatically creates corresponding code to support that object. By eliminating the need to write code just to display conventional interface elements, Visual Basic greatly simplified the creation of programs to be run on Windows-based platforms. These objects are typically stored in one or more dynamic link libraries (DLLs) that are loaded and run as necessary at application run-time. Since Visual Basic is an “open” programming languages, meaning that its syntax and command structures are known and available, third-parties have created and marketed a whole range of objects that can be added to a Visual Basic forms window to facilitate the creation of all sorts of different application programs.

With the release of Visual Basic 4.0, Microsoft extended Visual Basic to support software constructs that have certain object-oriented features by basing this release on its Component Object Model (COM). With Visual Basic 4.0, a new type of object, often referred to as a COM or ActiveX control or object was defined. A COM or ActiveX control is basically a component program object based on Microsoft's COM technologies, which can issue or raise events. With Visual Basic 4.0 and later releases, a developer similarly uses a forms layout package to drag and drop one or more ActiveX controls onto a form window. In addition, by double-clicking an ActiveX control on the form window, a code window is displayed. Inside this code window, the developer may insert text-based programming code to handle the events raised by the respective ActiveX control (i.e., an event handler). This code must comply with the syntactical and keyword constraints defined by Visual Basic in order for it to be properly executed at application run-time. By writing these event handlers, a developer can cause various ActiveX controls to share information and otherwise interact with each other greatly facilitating the creation of application programs.

FIG. 1 illustrates a conventional Visual Basic work space 100 that may be displayed on a computer screen. The work space 100 includes a Form window 102 and a tool palette 104. The tool palette 104 contains a plurality of icons, which represent individual controls, including a vertical scroll control 106 and a text label control 108, among others. A developer may select any of the controls contained on palette 104 to cause the selected control to appear on the Form window 102. By selecting the vertical scroll icon 106, for example, a corresponding vertical scroll image 110 is displayed on the Form window 102. A text label image 112 may be placed on the Form window 102 in a similar manner. At this point, however, there is no inter-relationship between the objects corresponding to vertical scroll image 110 and text label image 112. In order to establish some such relationship (e.g., causing the text label to display the current position of the vertical scroll), the developer must write a subroutine (e.g., an event handler). Each line or statement of the subroutine, moreover, must conform to the syntax and keyword commands of the underlying programming language (e.g., Visual Basic). Specifically, the developer selects the vertical scroll 110, thereby causing a code window 114 to be displayed on screen 100. Inside the code window 114, the developer writes a text-based subroutine 116 that causes the output of the vertical scroll 110 to be displayed in the text label 112.

When this program is subsequently run, images for the vertical scroll bar 110 and the text label 112 will appear on the screen of the user as part of a user interface. The text label 112, moreover, will display the position of the vertical scroll bar 110 (e.g., “2256”). If the user moves the slider bar of the vertical scroll, the contents of text label change to display the scroll bar's new position (e.g., “3891”). As shown, with Visual Basic, the developer need not “write” any code to cause the vertical scroll bar image 110 or the text label image 112 to be displayed on the computer screen during run time. In addition, during the programming phase, the developer may move and re-size these user interface elements simply by manipulating their appearance on the Form window 102 (e.g., with a mouse) in a conventional manner. Due to the relative ease with which application programs having user interface elements can be created, Visual Basic has become a highly popular programming tool. However, in order to develop a meaningful application program (i.e., one in which there is some inter-relationship between the user interface elements), the developer must write, in a text-based format, one or more subroutines. Thus, the developer must learn and is limited by the syntax and keyword structures of Visual Basic.

In addition to Visual Basic and its related products (e.g., Visual C++, etc.), several companies have created software development tools that are almost entirely visually oriented. That is, using these tools, a developer can create an executable application program without having to write a single line of text-based code. For example, National Instruments Corporation of Austin, Tex. has created a programming tool called LabVIEW™ for creating virtual instruments primarily for use in the instrumentation industry. Hewlett Packard Company of Palo Alto, Calif. has similarly created a programming tool called HP VEE for generating software programs for use in the electronic testing and data acquisition industries.

HP VEE provides a work area in which a developer can create a data flow diagram. The developer typically selects the objects for inclusion in his or her program from a pull-down menu. HP VEE provides a fixed number of these objects which have been tailored to provide functionality commonly used in the data acquisition industry. The developer may then “draw” data lines between these objects in the work area. In response to drawing these lines, HP VEE creates program steps that transfer data or other information between the respective objects. The developer must perform all of this graphically within the work area.

Web Services

Web services are self-contained, modular applications that can be described, published, located and invoked over a network, such as the World Wide Web, using standard Internet technologies. Web services perform functions that can range from simple operations to complicated business processes. Most web services operate in accordance with the Simple Object Access Protocol (SOAP) which defines messages for passing Remote Procedure Calls (RPCs) and data encoded by the eXtensible Mark-up Language (XML) to and from the web service. Typically, the Hyper Text Transport Protocol (HTTP) is used as the transport mechanism between the web service and the consumers of that service.

Recently, Microsoft released its NET framework, which includes Visual Studio .NET. This framework was specially designed by Microsoft to facilitate the creation of web applications, including web services. Specifically, a program developer can define a class that is to be exposed as a web service. The developer then creates certain methods and declares them to be public making them available as a service. Using the Web Service Description Language (WSDL) the programmer can detail where the web service is located and how to interact with it, thereby allowing others to access and invoke the web service.

To use a web service, a proxy web service class is typically created at the consumer site based on the WSDL description of the web service. Program objects created from the proxy web service class use SOAP over HTTP to communicate with the web service. More specifically, these objects handle the work of mapping parameters to XML elements and encapsulating the XML elements in SOAP messages for transmission to the web service. The proxy web service objects similarly recover parameters from the XML elements received in SOAP messages from the web service. A client application can then be created that interacts with the proxy web service object to specify the information to be sent to the web service and utilize the information returned from the web service. Web services are rapidly becoming a desirable way for creating applications and for enterprises to expose selected business logic. Nonetheless, it remains relatively difficult to create web services and clients capable of consuming those services.

### SUMMARY OF THE INVENTION

Briefly, the invention relates to a web service program object for use in developing application programs through a program-development environment that can access various web services. Using the program-development environment, a developer graphically specifies the logical operation of the application program in two-dimensions. The web service program object, which may have a corresponding icon for display within the graphical specification and a symbolic representation for display during application run-time, is specially configured to facilitate accessing existing web services by the application program. Using the web service program object, a program developer can specify the network address of a selected web service and can specify the methods and parameters for accessing the selected web service. Input values for the web service can be defined at design time. Input values may alternatively or additionally be specified by the program user at run-time. At run-time, the web service program object causes a web service proxy class to be created for accessing the web service. The web service program object in cooperation with the proxy class further causes the input values and methods to be sent to the web service and retrieves any output values generated by the web service. The output values retrieved from the web service may then be provided to other objects of the application program as indicated in the graphical specification that was created during design time.

### BRIEF DESCRIPTION OF THE DRAWINGS

The invention description below refers to the accompanying drawings, of which:

FIG. 1, previously discussed, is a highly schematic illustration of a conventional visual programming environment;

FIG. 2 is a computer system configured in accordance with the present invention;

FIG. 3 is a highly schematic illustration of the software components of the computer system of FIG. 2;

FIGS. 4A-4D are preferred illustrations of a graphical user interface in accordance with the present invention;

FIG. 5 is a highly schematic block diagram of a data structure for use with the present invention;

FIGS. 6A-6B and 7 are flow diagrams of preferred methods of the present invention;

FIGS. 8A and 8B are preferred illustrations of the graphical user interface including a window for receiving textual inputs;

FIGS. 9A-E are preferred illustrations of a graphical user interface including the web service icon of the present invention;

FIGS. 10A-10D and 11 are preferred illustrations of a run-time application window illustrating the operating characteristics of the web service program object of the present invention; and

FIG. 12 is a highly schematic illustration of textually defined event handler code.

### DETAILED DESCRIPTION OF AN ILLUSTRATIVE EMBODIMENT

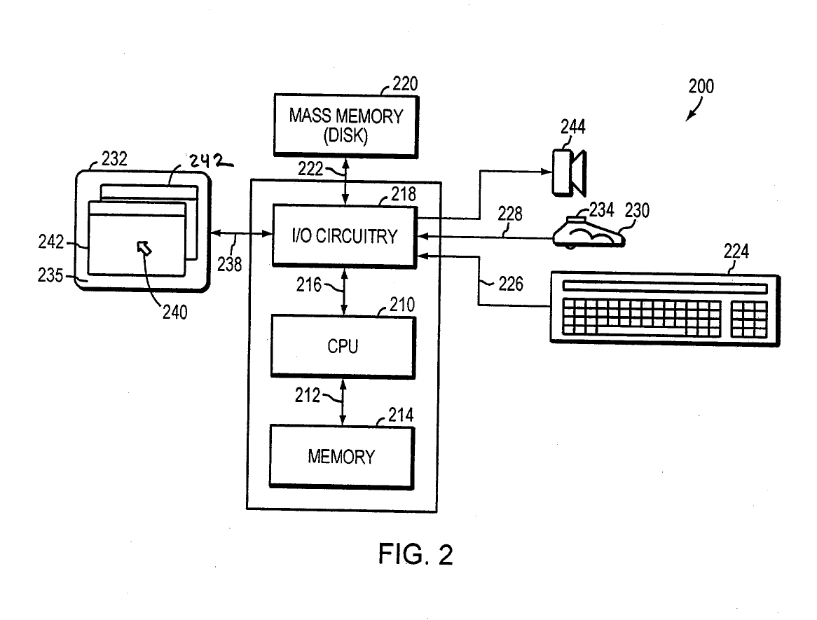

FIG. 2 illustrates a computer system 200 comprising a central processing unit (CPU) 210 coupled between a memory 214 and input/output (I/O) circuitry 218 by bi-directional buses 212 and 216, respectively. The memory 214 typically comprises random access memory (RAM) for the volatile storage of information, including application programs and an operating system, and read only memory (ROM) for persistent storage of the computer's configuration and basic operating commands. As further described herein, the application programs and the operating system interact to control the operations of the CPU 210 and the computer system 200.

The I/O circuitry 218 may be connected to a mass memory storage unit 220, such as a disk drive, via bi-directional bus 222. In the typical system 200, the memory storage unit 220 contains instructions that can be read by the CPU 210 in order to configure system 200 to provide the program-development features of the present invention. Cursor/pointer control and input devices, such as a keyboard 224 and a mouse 230, connect to the I/O circuitry 218 via cables 226 and 228, respectively. The mouse 230 typically contains at least one button or switch 234 that may be operated by a user of the computer system 200. A monitor 232 having a display screen 235 is also connected to the I/O circuitry 218 via cable 238. A pointer or cursor 240 may be displayed on screen 235 and its position can be controlled via the mouse 230 or the keyboard 224, as is well-known in the art. As described further herein, a window environment is displayed on the display screen 235 of the monitor 232. The window environment includes one or more windows 242. A speaker system 244 may also be connected to I/O circuitry 218.

In general, the I/O circuitry 218 receives information, such as control and data signals, from the mouse 230 and the keyboard 224, and provides that information to the CPU 210 for storage on the mass storage unit 220 or for display on the screen 235. The I/O circuitry 218 preferably contains the necessary hardware, e.g., buffers and adapters, needed to interface with the mouse 230, the keyboard 224 and the display monitor 232. The computer system 200 further includes one or more communication components, such as a Network Interface Card (NIC) or a modem (not shown), for connecting the computer system 200 to a computer network, such as the Internet.

A suitable computer system 200 for use with the present invention includes a personal computer, such as those manufactured and sold by International Business Machines Corp. of Armonk, N.Y., Compaq Computer Corp. of Houston, Tex. or Apple Computer, Inc. of Cupertino, Calif. The present invention may also be practiced in the context of other types of computers, including Unix-type workstations from Sun Microsystems, Inc. or Hewlett Packard. All of these computers have resident thereon, and are controlled and coordinated by, operating system software, such as Microsoft Windows® 95, 98 or NT, MAC OS or UNIX.

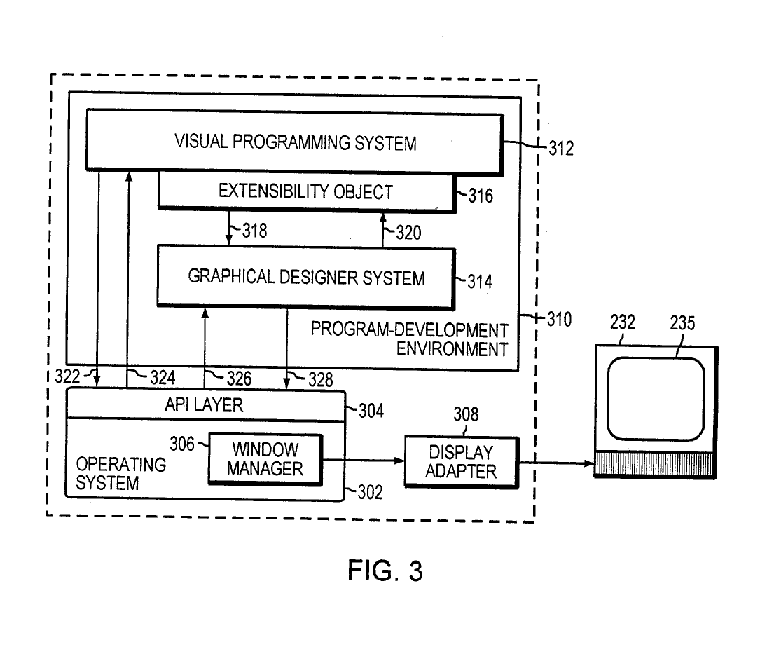

FIG. 3 is a highly schematic illustration of the software components of the computer system 200 of FIG. 2. These components include an operating system 302 having an application programming interface (API) layer 304 through which other application programs executing on computer system 200 may interact with the operating system 302. In particular, operating system 302 exchanges task commands to control the operations of the computer system 200 as well as notifications regarding various activity (e.g., windows events) with these other applications. The operating system 302 further includes system facilities, such as a window manager 306 which, inter alia, can directly implements those task commands and windows events. These system facilities are basically software routines within the operating system 302 that interoperate with lower layers of the operating system 302 and are responsible for managing various services and functions. The window manager 306, for example, may use a graphics system and a screen buffer to draw and manipulate windows on the display screen 235 of monitor 232. Under the control of various hardware and software in the computer system 200, the contents of the screen buffer may be read out and provided to a display adapter 308. The display adapter 308 contains hardware and software (sometimes in the form of firmware) which converts the information from the screen buffer to a form which can be used to drive the display screen 235 of monitor 232.

The lower-layers of the operating system 302 also include device drivers for interfacing directly with the computer hardware. For each physical device, such as the mass storage unit 220 (FIG. 2), a device driver is provided to accept requests, to read or write data or to determine the status of the devices. Communication between the physical devices and CPU 210 (FIG. 2) may be effected either through polling of the device drivers or via interrupts.

In accordance with the present invention, a program-development environment 310 is also executing on the computer system 200. The program-development environment 310 includes an extensible visual programming system 312 and a graphical designer system 314. The visual programming system 312, in turn, may include an extensibility object 316, which provides an interface for communication between the programming system 312 and the graphical designer system 314 as indicated by arrows 318 and 320. Arrow 320 represents calls from the designer system 314 to the programming system 312, while arrow 318 represents calls from the programming system 312 to the designer system 314. Additionally, both the graphical designer system 314 and the visual programming system 312 may communicate directly with the operating system 302, e.g., exchange task commands and windows events, via API layer 304, as indicated by arrows 322-328.

In the illustrative embodiment, the extensible visual programming system 312 is Visual Basic 5.0 or higher (preferably 6.0) or more preferably Visual Studio .NET from Microsoft Corp., and the graphical designer system 314 is configured as a Visual Basic or Visual Studio Add-In. Nonetheless, those skilled in the art will recognize that the present invention may also be advantageously used with other extensible visual programming systems, such as Visual C++, Visual J++, Visual Cafe, Visual InterDev, Delphi (for Pascal), etc. As described in more detail below, graphical designer system 314 allows the developer to switch the program-development environment 310 seamlessly between a graphical programming paradigm and a textual paradigm. The development environment 310 generates event handler procedures or program code for incorporation into the software program being developed, in response either to textual inputs or to graphical inputs from the developer.

To utilize the program-development environment 310, the developer first opens it in a conventional manner. For example, the development environment 310 may be represented by an icon on the user's desktop, which may be opened by “clicking” the icon using mouse button 234 (FIG. 2) in a conventional manner. Alternatively or in addition, the development environment 310 may be listed as one of the available programs within a Programs folder of a Start menu or by using a Run command. The development environment 310 may be configured, upon opening, to launch the corresponding visual programming system 312 and graphical designer system 314.

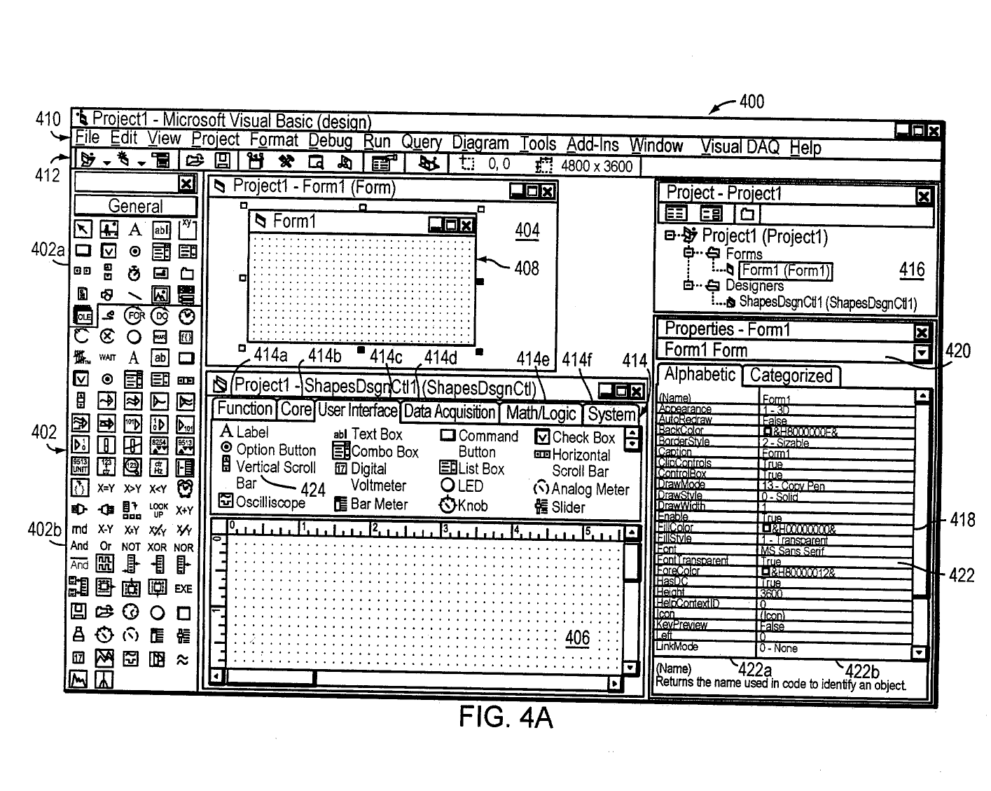

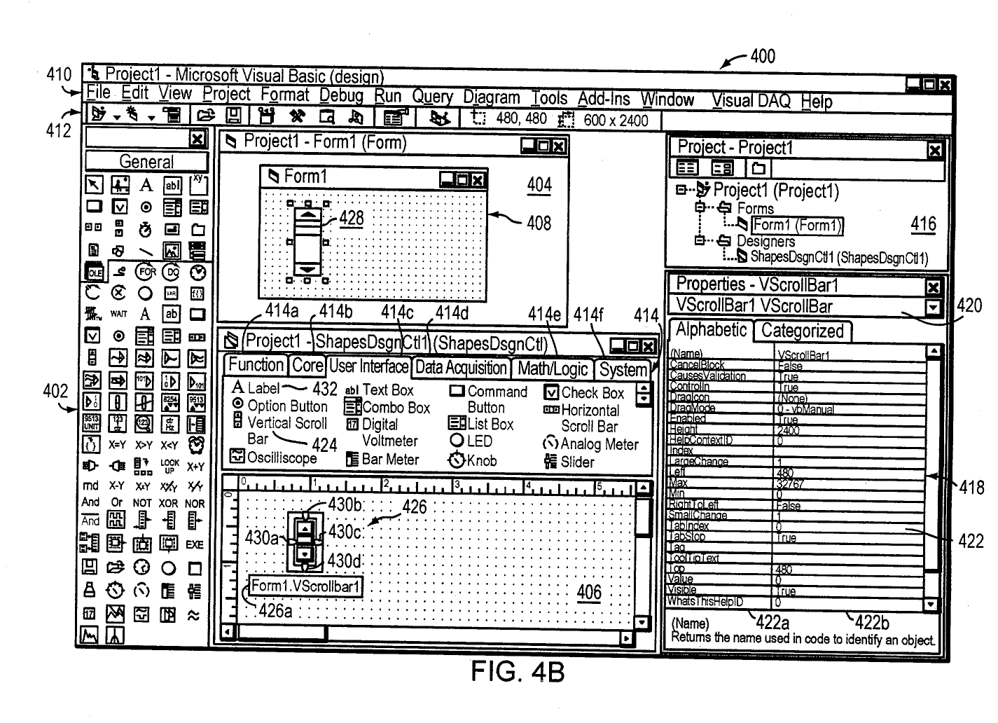

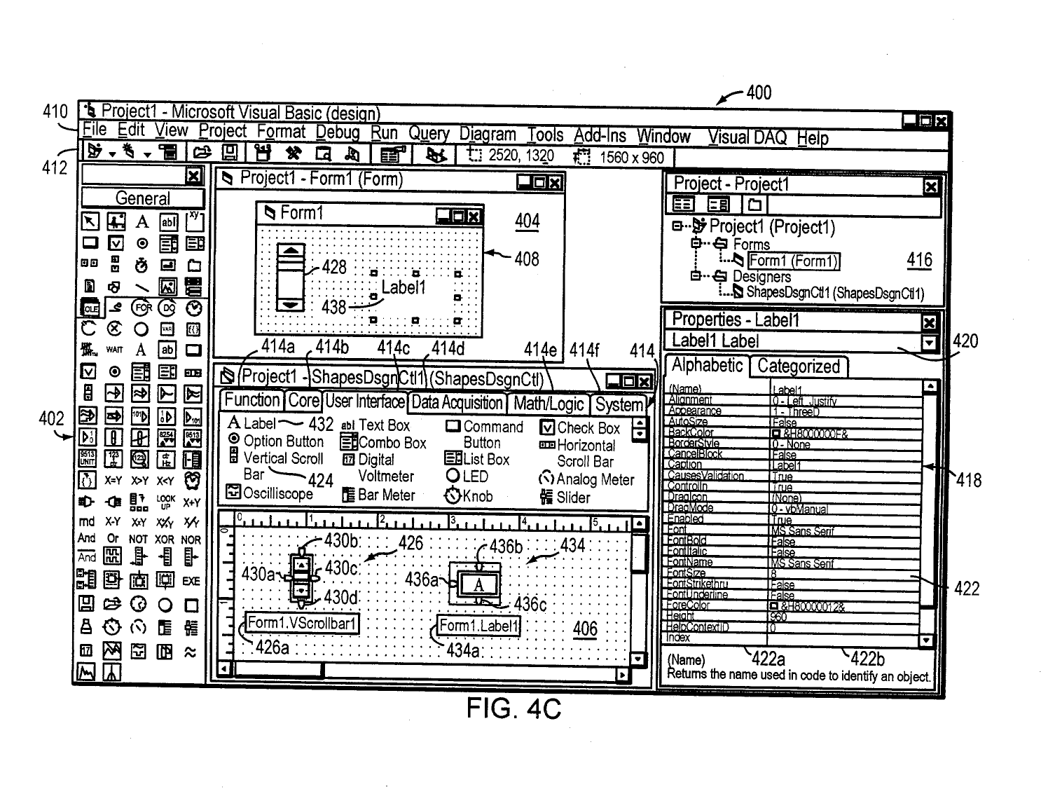

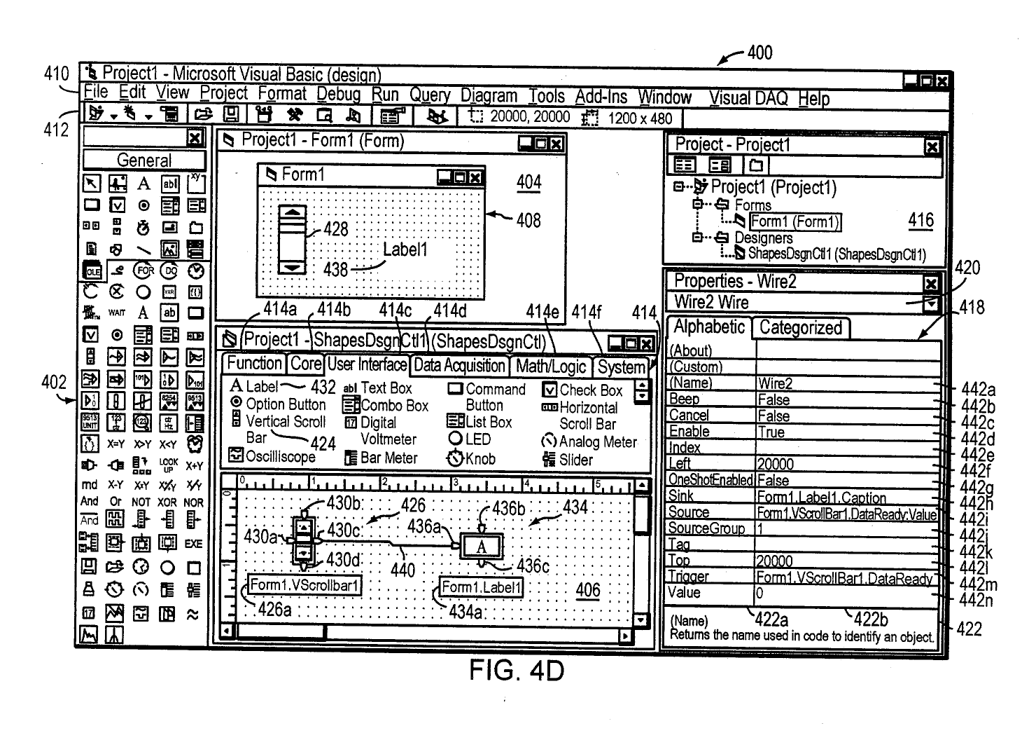

Upon opening, the graphical design system 314 cooperates with the visual programming system 312 to present a unified and coherent graphical user interface (GUI) to the developer on display screen 235 of monitor 232. FIG. 4A shows a preferred representation of this GUI 400. The GUI 400 has several elements, including at least one toolbox 402 that contains a plurality of icons. Each icon represents a corresponding component control or program object class that is available for use by the developer in creating application programs. The application programs that are ultimately created by the development environment 310 can be considered component-oriented, since they, among other things, call upon class factories that allocate memory for object members and ensure that the respective class methods have been loaded. The GUI 400 further includes one or more form windows 404 and a designer window 406. The form window 404 represents a container application that can “hold” instances of the control component or program object classes selected by the developer from the toolbox 402 for inclusion in the particular software program. By default, form window 404 includes a user form program object 408. The user form program object 408 basically provides an image of the user interface being developed for the application program. The GUI 400 may further include a menu bar 410 with a plurality of pull-down menu items and a toolbar 412 that contains a plurality of buttons providing short-cuts to commonly used tasks or functions.

As described below, the designer window 406 is configured to display a corresponding symbol for each program object added to the form window 404. These symbols, moreover, may be graphically linked together in order to create a two-dimensional block diagram that logically represents the application program that is being developed. The designer window 406 also includes its own toolbar 414, which may be divided into a plurality of sub-toolbars 414a-f, each having a corresponding tab that may be labeled (e.g., Function, Core, User Interface, Data Acquisition, Math/Logic and System). Disposed on each sub-toolbar 414a-f are one or more icons. Each icon represents a corresponding control component or program object class, the symbolic representation of which may be caused to appear in the designer window 406.

Each control component or program object instantiated from a corresponding class represented by an icon on toolbox 402 and/or toolbar 414 has pre-defined properties, methods and events. In addition, each program object typically performs some useful function, such as a Boolean operation (e.g., AND, OR, etc.), a mathematical operation, a data acquisition operation (typically from some transducer coupled to the I/O circuitry 218 of the computer 200), renders some comparison (e.g., less than, greater than, equal to, etc.), and so on. In the preferred embodiment, these control components or program objects are compatible with the ActiveX or Component Object Model (COM) technologies developed and made publicly available by Microsoft Corporation. The creation of ActiveX or COM objects is well-known to those skilled in the art and will not be described in detail here. For example, the creation of such objects is described in D. Appleman Developing COM/ActiveX Components with Visual Basic 6 (1999). The program objects and their classes may be stored in one or more dynamic link libraries (DLLs) within the memory 214 of the computer 200. The graphical designer system 314 and/or the visual programming system 312 preferably includes a link (e.g., a pointer) to these DLLs so that the available program object classes may be displayed as icons on the toolbox 402 and on the designer toolbar 414.

The program objects intended for use with the program-development environment 310 of the present invention are preferably pre-configured to have certain novel properties, methods and events. These additional properties, methods and events include the following:

PROGRAM OBJECT PROPERTIES

| Name | Data Type | Description |
|---|---|---|
| CancelBlock | Boolean | If set, prevents program object from |
| | | executing or from completing execution of |
| | | its function. |
| ControlIn | Boolean | When used, controls when program object |
| | | begins execution of its function. |
| InvalidProperty | Integer | Invalidates an identified property of the |
| | | program object in order to ensure orderly |
| | | execution. |

PROGRAM OBJECT EVENTS

| Name | Description |
|---|---|
| RubBlock | Occurs when program object is about to commence |
| | executing its corresponding function. |
| InvalidateGroup | Occurs when program object is about to up-date one |
| | or more of its properties as a result of executing its |
| | corresponding function. |
| DataReady | Occurs after program object has up-dated one or more |
| | of its properties as a result of executing its |
| | corresponding function. |
| RateReady | Issued by program objects that perform scanning |
| | operations upon successful completion of a scan. |
| StatusReady | For program objects that operate in one or more modes |
| | or states, this event occurs repeatedly while the |
| | program object executes its corresponding function. |
| ControlOut | Occurs when program object has completed execution. |
| ErrorOut | Occurs if program object generated an error during |
| | execution and may contain an identification of the type |
| | of error that was generated. It may also occur to |
| | indicate that no error condition was generated during |
| | execution. |

where Boolean means that the property may be set to True or False and Integer refers to any integer.

The GUI 400 may also include additional windows. For example, GUI 400 may include a project explorer window 416, which provides a hierarchical view of the current project. A project simply refers to the collection of files (e.g., form files, binary data files, class module files, etc.) and objects associated with the application program being developed. GUI 400 may also include a properties window 418 that displays the properties of a selected program object residing in the form window 404. The properties window 418 includes a pull-down object list 420, that contains a list of all of the program objects currently residing in the form window 404, and a property window 422, that is divided into two columns: a name column 422a and a current value column 422b. The name column 422a identifies all of the properties associated with the program object selected in the object list 420, while the current value column 422b shows the values that are currently associated with those properties.

To generate an application program, the developer selects one or more icons preferably from the designer toolbar 414 that perform requisite functionality for carrying out the tasks of the application program. In response, the program-development environment 310 places corresponding symbols in the designer window 406. The developer then graphically links these symbolic representations by drawing “wires” between them in order to create a two-dimensional graphical representation of the program. He or she will typically do this by using the mouse 230 (FIG. 2) or similar input device to cause the cursor 240 to move from one symbol to the next, although other graphical or even keyboard inputs may be used to perform the “graphical input”. In response, the graphical designer system 314 of the program-development environment 310 generates an event handler procedure to be run as part of the application program being developed. In accordance with the invention, the development environment 310 also includes in the same resultant application program other event handlers, which the developer optionally specifies textually by entering commands and other information in a code window that the development environment 310 also provides on GUI 400. That is, the development environment 310 gives the developer the option of using textual inputs in order to specify event handlers that might otherwise be impossible or more difficult to represent graphically.

Suppose, for example, that the developer wishes to create a simple software program in which the position of a vertical scroll bar is displayed in a label. From the User Interface designer sub-toolbar 414c, the developer first selects the vertical scroll bar icon 424. To select icon 424, the developer uses the mouse 230 (FIG. 2) to position the pointer 240 over the vertical scroll bar icon 424 and activates (e.g., “clicks”) the mouse button 234. This mouse click is a conventional windows event that is received by the operating system 302 (FIG. 3) in a conventional manner. Since the mouse click occurred over the designer window 406, operating system 302 passes this window event to the graphical designer system 314 of the program-development environment 310 by a communication mechanism represented by arrow 326, and the designer system 314 treats the windows event as a selection of the vertical scroll bar class by the developer.

As shown in FIG. 4B, in response to the selection of icon 424 from the User Interface designer toolbar 414c, the graphical designer system 314 causes a symbolic representation 426 of the program object corresponding to the vertical scroll bar class to be displayed in the designer window 406. The designer system 314 also issues a call to the visual programming system 312 through its extensibility object 316 as represented by the communication mechanism of arrow 320. This call directs the visual programming system 312 to instantiate a program object from the vertical scroll bar class and add that program object to the container application represented by the form window 404. That is, form window 404 may maintain a linked list of pointers to program objects that are considered to “belong” to the form, and in this list is placed a pointer to the vertical scroll bar program object that was instantiated. Since the vertical scroll bar is a user interface element, the visual programming system 312 also causes a vertical scroll bar image 428 to appear in the user form object 408. Vertical scroll bar image 428 basically corresponds to the way in which the vertical scroll bar user element will appear in the respective user interface at run-time of the application program being created. Vertical scroll bar image 428 may be moved and/or re-sized by the developer in a conventional manner.

As part of the process of adding a program object to the form window 404, the visual programming system 312 also assigns a name to that program object. The name may consist of the object's class followed by an integer, e.g., VScrollBar1 for the first vertical scroll bar added to form window 404. The name uniquely identifies the program object within the form 408. Upon adding the program object to the form window 404, the visual programming system 312 preferably returns the assigned name to designer system 314 by a communication mechanism represented by arrow 318. The program-development environment 310 may then display a name 426a as part of the symbolic representation 426 of the object in the designer window 406. The name displayed in designer window 406, e.g., Form1.VScrollBar1, may be derived by concatenating the name of the program object, e.g., VScrollBar1, with the name of the form window in which it resides, e.g., Form1.

As indicated, the symbolic representations appearing in designer window 406 are used by the developer to create a two-dimensional graphical representation that logically corresponds to the application program being developed. To facilitate the generation of such diagrams and the creation of corresponding event handlers by the program-development environment 310, each symbolic representation in designer window 406 preferably includes one or more terminals disposed about it. These terminals, moreover, are associated with some pre-defined combination of the properties, methods and/or events of the respective program object that is symbolically represented. Vertical scroll bar 426, for example, has four terminals 430a-d. In order to facilitate a generally left to right passing of data, and a top to bottom flow of execution control, the terminals of all symbolic representations appearing within the designer window 406 preferably conform to the following general rules. Terminals on the left side of a given symbolic representation, such as terminal 430a of vertical scroll bar 426, preferably correspond to a property used as an input by the respective program object. Terminals on the right side of a symbolic representation, such as terminal 430c of vertical scroll bar 426, preferably correspond to (i) an optional property generated as an output and (ii) an event of the respective program object. Terminals on the top of a symbolic representation, such as terminal 430b preferably correspond to a property which, when changed to a new value, triggers execution of the respective program object, and terminals on the bottom of a symbol, such as terminal 430d of vertical scroll bar 426 preferably correspond to an event that occurs when the respective program object has completed execution of its respective function.

The vertical scroll bar program object, for example, has a plurality of pre-defined is properties, methods and events. In particular, the properties of the vertical scroll bar program object include: Enabled, Height, Width, Minimum, Maximum, Value, etc. The methods associated with the vertical scroll bar program object include Move, Drag, SetFocus, ShowHelp, Refresh, etc. The events associated with the vertical scroll bar program object include RunBlock, DataReady, ControlOut, etc.

Terminal 430a at symbol 426 is preferably associated with the vertical scroll bar's Value property. Terminal 430b is associated with the scroll bar's ControlIn property. Terminal 430c is associated with the vertical scroll's Value property and its DataReady event. Terminal 430d is associated with the object's ControlOut event.

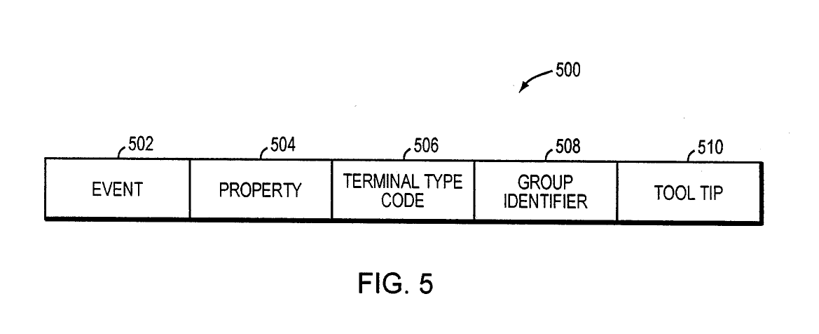

The association of properties and events to terminals is preferably maintained in a plurality of terminal data structures stored at memory 214 or 220. In particular, for each type or class of program object represented by an icon on the designer toolbar 414, there are one or more corresponding terminal data structures, depending on the number of terminals supported by the respective program object class. FIG. 5 is a highly schematic block diagram of a preferred terminal data structure 500. The terminal data structure 500 has at least four fields. A first field 502 preferably contains the name of the event, if any, that is associated with the particular terminal. A second field 504 preferably contains the name of the property, if any, that is associated with the particular terminal. If there is no event or property associated with the given terminal, then respective field 502 or 504 is set to null or de-asserted. A third field 506 preferably contains a code that identifies the particular type of terminal. In the illustrative embodiment, there are four types of terminals: data input, data output, control input and control output, and each type has a corresponding code. To the extent the data structure 500 corresponds to a data output type, a fourth field 508 is preferably used to store a group identifier. For a given type or program object class, the group identifier associates multiple data output type terminals whose corresponding properties are related to one another. For example, a joy stick object may have separate data output terminals for its “x” and “y” locations. Nevertheless, subsequent program objects should probably treat these two values as a single data point. Accordingly, the data output terminals associated with joy stick's “x” and “y” locations would preferably have the same group identifier. A fifth field 510 preferably contains a tool tip. A tool tip is a piece of descriptive text which is displayed to the developer when the cursor lingers over the respective terminal (e.g., “control input”, “error output”, and so on). The program-development environment 310 preferably maintains or otherwise has access to pointers to these various terminal data structures 500 within memory 214 (FIG. 2) (e.g., as a linked list). The pointers, moreover, may be mapped by the program-development environment to the names of the corresponding object classes so that, given the name of some object class, the program-development environment 310 can access the terminal data structures for each control or program object that has been instantiated from that class.

Symbolic representations appearing in the designer window 406, including the terminals, are preferably generated by the program-development environment 310 from respective bit maps stored in one or more image files within memory 214 (FIG. 2). The program-development environment 310 preferably maintains an association of bit maps to icons on the designer toolbar 414 so that when a developer selects a particular icon, the program-development environment 310 can direct the window manager 306 to draw the corresponding image from the appropriate bit map. Symbolic representations can also be moved about the designer window 406 by dragging them around with the mouse 230.

The developer then selects the next program object or control for use in the application program being created. Suppose that the developer selects the label icon 432 (FIG. 4B) from the User Interface sub-toolbar 414c. As shown in FIG. 4C, the program-development environment 310, in response, causes a symbolic representation 434 of a label program object to appear in designer window 406. Symbolic representation 434 also includes a plurality of terminals 436a-c, and may further include a name 434a. The program-development environment 310 additionally directs the visual programming system 304 to add a label program object to form window 404. Since the label program object is also a user interface element, like the vertical scroll bar, the visual programming system 304 additionally causes a label image 438 to be drawn on the user form object 408.

The label program object has its own pre-defined properties, methods and events. For example, the properties of the label program object include Height, Visible, Font, BackColor, Caption, ControlIn, CancelBlock, etc. Its events include RunBlock, Cons trolOut, etc. Data input terminal 436a of symbol 434, moreover, is preferably associated with the label's Caption property. Terminal 436b is associated with the ControlIn property, and terminal 436c is associated with the ControlOut event. Note that symbol 434 does not have any data output terminals.

Generation of Event-Handler Code Through Graphical Inputs

At this point, the developer has two program objects residing in the form window 404. With the prior art systems, such as the Visual Basic® programming system from Microsoft Corporation, the developer would now have to write one or more textual event handlers in order to have the position of the vertical scroll bar displayed in the label. As described above, the need to learn the keywords and syntax governing such textual event handlers has been a drawback to the use of Visual Basic by non-programmers, including scientists and engineers. With the program-development environment 310 of the present invention, the developer may cause the development environment 310 to generate corresponding handler procedure by simply graphically linking the symbolic representations of the program objects in the designer window 406 with one or more novel wire constructs. The developer need not generate any text-based code at all. Unlike the prior-art systems that only enable the user to graphically provide event handlers, though, the program-development environment 310 of the present invention also affords the developer the ability to provide or modify event handlers textually. It thereby frees the developer of the constraints and limitations imposed by such prior-art graphical programming tools.

To cause the position of the vertical scroll bar image 428 to be displayed in the label image 438 at application run-time, the developer graphically links the symbolic representation 426 of the vertical scroll bar program object to the symbolic representation 434 of the label program object using a wire construct, rather than writing a textual event handler. To connect symbols 426, 434 with a wire construct, the developer moves the cursor 240 (FIG. 2) to terminal 430c (FIG. 4C) at symbol 426 using the mouse 230. As described above, terminal 430c is associated with both the DataReady event and the Value property of the respective vertical scroll bar program object, i.e., VScrollBar1, which resides on the form window 404. With the cursor 240 over terminal 430c, the developer preferably executes a mouse click using mouse button 234. Since this mouse click occurred in the designer window 406, the operating system 302 (FIG. 3) passes the respective windows event to the designer system 314 by the communications mechanism represented by arrow 326. In response, the designer system 314 directs the operating system 302 to switch the mouse 230 from “cursor mode” to “line drawing mode” through a call via arrow 328. In particular, designer system 314 directs the operating system 302 to modify the appearance of the cursor 240 and to begin tracing subsequent mouse 230 movement with a line, whose first end is anchored to terminal 430c. Thus, as the developer drags the mouse 230 away from symbolic representation 426, a line emanates from terminal 430c following the movement of the mouse 230.

The developer preferably extends this line to terminal 436a of symbolic representation 434, which corresponds to label program object Label1 residing on form window 404. When the free end of this line reaches terminal 436a, the developer preferably executes a second mouse click. Again, the corresponding windows event is passed by the operating system 302 to the designer system 314 and it, in response, causes the free end of the line to become attached to terminal 436a. Designer system 314 also directs the operating system to stop tracing mouse movement with a line and to return the cursor 240 to its original appearance. FIG. 4D is an illustration of the GUI 400 with a wire construct 440 extending between the two symbolic representations 426, 434.

In response to graphically connecting or linking two symbols in the designer window 406, the program-development environment 310 creates event handler program code that sets the label object's Caption property to the value of the vertical scroll bar object's Value property when the vertical scroll bar object's DataReady event occurs. Clearly, there are several ways in which this can be accomplished. For example, Visual Basic code for handling the indicated event (e.g., DataReady) and affecting the designated property (e.g., Caption) could be generated and added to the application program, and that event handler program code could then be compiled or interpreted in the normal manner at run-time. Preferably, though, the program-development environment 310 instantiates a new control or program object, a wire program object, adds this new object to the form window 404 and sets its properties in a predetermined manner. The basic function of the wire program object is to retrieve the Value property from the vertical scroll bar object in response to the DataReady event and to set the Caption property of the label program object to that Value. That is, this new object basically provides event handler functionality for other program objects residing in the form window 404.

Specifically, the graphical designer system 314 directs the visual programming system 312 through calls to its extensibility object 316, as arrow 320 indicates, to instantiate a wire component control or program object from the wire object class and to add this object to the form window 404. That is, form window 404 adds a pointer to the wire program object to its linked list of controls. It should be understood that the wire construct 440 appearing in the designer window 406 is preferably just a symbolic representation of the wire program object added to the form window 404. The visual programming system 312 also assigns a name to this program object, e.g., Wire2, which it returns to the designer system 314. As described below, as part of its initialization procedure, designer system 314 preferably directs the visual programming system 312 to instantiate and add a wire program object, which may be named Wire1, to the form window 404. Thus, the “first” wire that is drawn on the designer window 406 by the developer actually corresponds to the second wire program object to be instantiated and added to the form window 404. Therefore, this wire program object is typically assigned the name Wire2.

The wire control or program object is itself a program module having its own predefined properties, methods and events. In the illustrative embodiment, each wire control or program object has the following properties, methods and events:

WIRE CONTROL PROPERTIES

| Name | Data Type | Description |
|---|---|---|
| Name | Text | Specifies the name of the wire program |
| | | object. |
| Beep | Boolean | Determines whether the wire program |
| | | object emits a “click” sound whenever |
| | | it is triggered. |
| Cancel | Boolean | Determines whether the wire program |
| | | object executes upon being triggered or |
| | | invoked. |
| Enabled | Boolean | Determines whether the wire program |
| | | object executes in response to its |
| | | triggering event. |
| Index | Text | Distinguishes between two or more wire |
| | | program objects having the same name. |
| Left | Integer | Specifies the x-coordinate position of an |
| | | image of the wire program object |
| | | appearing on the user form object. |
| OneShotEnabled | Boolean | If Enabled property is False, determines |
| | | whether the wire program object should |
| | | nonetheless execute one time. |
| Sink | Text | The name of the sink program object and |
| | | its respective property to which the wire |
| | | program object is graphically connected. |
| Source | Text | The name of the source program object |
| | | and its respective property to which the |
| | | wire program object is graphically |
| | | connected |
| SourceGroup | Integer | Used to organize related properties of the |
| | | source program object. |
| Tag | Text | Assigns an additional identifier to the wire |
| | | program object, typically for use by the |
| | | application program. |
| Top | Integer | Specifies the y-coordinate position of an |
| | | image of the wire program object |
| | | appearing on the user form object. |
| Trigger | Text | The name of the program object and its |
| | | respective event, the occurrence of which |
| | | causes the wire program object to execute. |
| Value | Variant | A data store, the contents of which can be |
| | | copied from the source, modified, if |
| | | desired, and passed to the sink by the wire |
| | | program object. |

WIRE CONTROL METHODS

| Name | Description |
|---|---|
| Run | Causes the wire program object to execute. |

WIRE CONTROL EVENTS

| Name | Description |
|---|---|
| Action(Value) | Occurs in response to the wire program being triggered |
| | or run. The argument corresponds to the current value |
| | of the wire's Value property prior to any event |
| | handling routines. |
| Done | Occurs once the wire program object has finished |
| | propagating its Action event and setting the specified |
| | sink property, provided that the Cancel property is still |
| | false. |

where Boolean means that the property may be set to True or False, Text means that the property is an alpha-numeric string, Integer means that the property is an integer, and Variant means that the property can take any of the data formats specified by the corresponding variant structure definition.

After the visual programming system 312 has added the wire program object to the form window 404 and returned its name, the designer system 314 next sets the various properties of this wire program object. The wire's properties, moreover, may be displayed in the property window 422 (FIG. 4D) of property window 418, as indicated by rows 442a-n, by selecting the wire program object, e.g., Wire2, from pull-down object list 420. The particular values to which the wire's properties are initially set depends on the particular program objects that have been logically connected by the wire construct 440 within designer window 406. For each wire control or program object, the designer system 314 identifies three corresponding program objects: a “source” program object, a “sink” program object and a “trigger” program object. Designer system 314 also examines the terminal data structures 500 that are associated with the graphically linked terminals 430c and 436a. Designer system 314 then uses this information to set the properties of the respective wire program object, i.e., Wire2.

It should be understood that attempts by the developer to wire a first input terminal to a second input terminal or a first output terminal to a second output terminal are rejected by the program-development system 310.

To identify the source, sink and trigger program objects, designer system 314 determines the names of the program objects that have been linked by the subject wire construct 440, the form window(s) on which those program objects reside, and the particular types of terminals that have been graphically linked by wire construct 440. As indicated above, information regarding the names of the graphically linked program objects and the form window(s) on which they reside is returned to the designer system 314 by the visual programming system 312 when system 304 adds those program objects to the form window 404. Thus, designer system 314 already has this information in its allocated portion of memory 214. Information regarding the types of terminals that have been linked is derived by the designer system 314 from the terminal type code fields 506 for the terminal type data structures 500 associated with the respective terminals, i.e., terminals 430c and 436a. The designer system 314 uses this terminal type information to determine which of the linked program objects should be considered the source object, which program object should be considered the sink object, and which program object should be considered the trigger object. In the preferred embodiment, the program object whose linked terminal is either a data output or control output type is treated as the source object, while the program object whose linked terminal is a data input or control input type is treated as the sink object. Here, linked terminal 430c at symbolic representation 426 is a data output terminal, while terminal 436a at symbolic representation 434 is a data input terminal. Thus, the designer system 314 considers the VScrollBar1 program object to be the source object and the Label1 program object to be the sink object for respective wire object, i.e., Wire2.

After identifying the source and sink control objects, the designer system 314 is ready to set the Sink, Source and Trigger properties 442h, 442i and 442m of Wire2. The wire program object's Source property is preferably a concatenation of the following information: the name of the form window 404 on which the source program object resides, e.g., Form1, the name of the source program object, e.g., VScrollBar1, and the property associated with the linked terminal at the source program object, e.g., Value. The Source property may further be concatenated with the event associated with the linked terminal at the source program object, e.g., DataReady. The designer system 314 preferably obtains the source event and property parameters for use in setting the wire's Source property from the event field 502 and property field 504 from the terminal data structure 500 associated with linked terminal at the source program object, i.e., terminal 430c. For data output type terminals, such as terminal 430c, system 314 similarly obtains the SourceGroup property parameter 442j from the group identifier field 805 from the corresponding terminal data structure 500.

The wire program object's Sink property 442h is preferably a concatenation of the following information: the name of the form window 404 on which the sink program object resides, e.g., Form1, the name of the sink program object, e.g., Label1, and the property associated with the linked terminal at the sink program object, e.g., Caption. Again, the designer system 314 preferably obtains the sink property parameter from the property field 504 of the terminal data structure 500 associated with linked terminal at the sink program object, i.e., terminal 436a. The wire program object's Trigger property 442m is preferably a concatenation of the following information: the name of the form window 404 on which the source program object resides, e.g., Form1, the name of the source program object, e.g., VScrollBar1, and the event associated with the linked terminal at the source program object, e.g., DataReady. As described above in connection with setting the Source property, this information may be derived from the name of the source program object and also from the contents of the event field 502 of the terminal data structure 500 associated with linked terminal at the source program object, i.e., terminal 430c. It should be understood that the designer system 314 may derive and set the Source property 442i first and then strip off the specified property of the source (e.g., Value), which was obtained from field 504 of the corresponding terminal data structure 500, to set the Trigger property 442m.

The wire program object preferably includes built-in functionality that automatically sets its Beep, Cancel and OneShotEnabled properties 442b, 442c and 442g to FALSE, and its Enabled property 442d to TRUE. The Value property 442n is preferably set, at least initially, to null or is otherwise de-asserted.

In the preferred embodiment, wire program objects are not intended to appear in any of the user interfaces that may be generated at run-time of the application program being developed. Accordingly, the Left and Top properties 442f, 442l of all wire program objects, which specify where on the user form object 408 an image of the object should appear (and, hence, where on the run-time user interface those images should appear), are set to default values (e.g., “20000”) that are sufficiently high so as to “place” the image of the wire program objects off of the user form object 408. Thus, at run-time, no image appears on the user interface corresponding to any wire program object that may nonetheless reside on the corresponding form window. Additionally, or alternatively, the wire object's Visible property may be set to FALSE.

Each wire program object instantiated and added to the form window 404 in response to graphical inputs of the developer includes at least some program code that may be called upon to execute when the respective application program is run. This program code, which is generated solely in response to the developer having graphically linked the symbolic representations of two program objects, basically causes the sink program object, e.g., Label1, to execute or otherwise take some action in response to an event generated by a trigger program object, e.g., VScrollBar1, and using some property of the source control object. That is, the wire object represents event handler procedures or code incorporated within the application program.

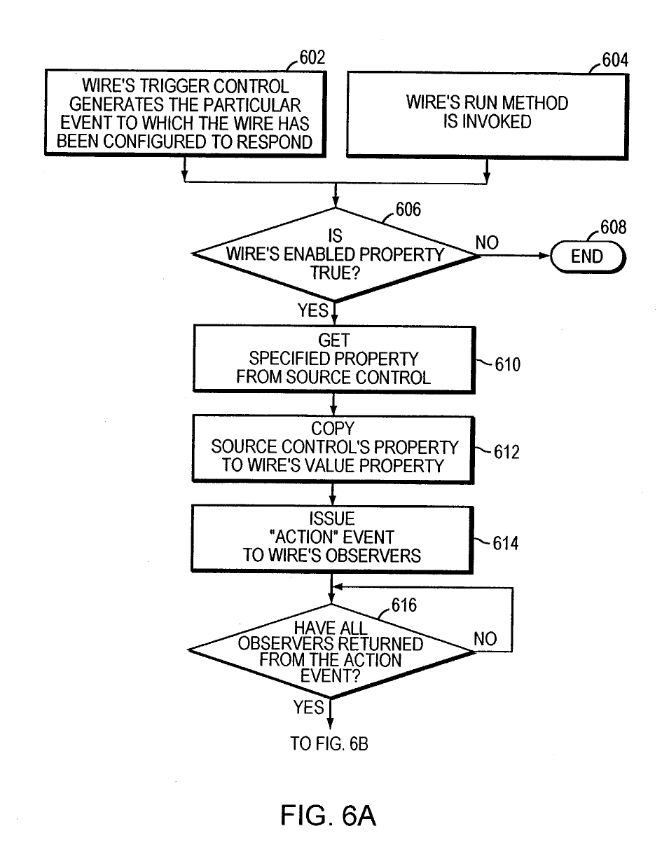

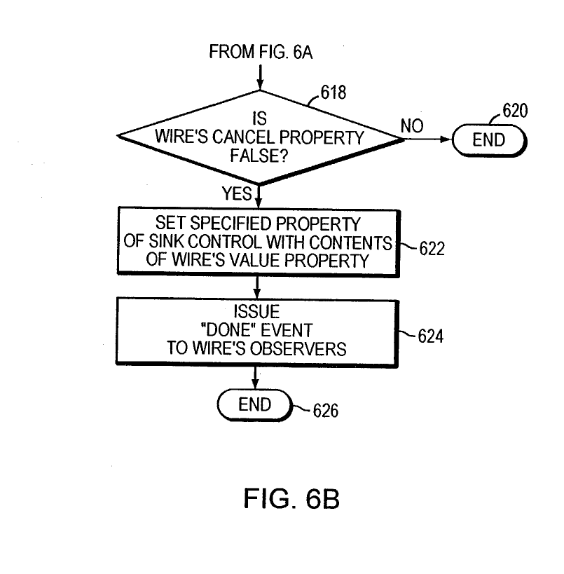

FIGS. 6A and 6B are a flow diagram of the steps corresponding to the preferred event handler procedure or code generated by the program-development environment 310 in response to such graphical inputs from the developer. This procedure may be called upon to execute during run-time of the application program. Running of the graphically generated event handler procedure may be initiated in one of two ways. First, it is initiated when the trigger control component, as identified in the wire's Trigger property 442m, e.g., VScrollBar1, issues the particular event also identified in the wire's Trigger property 442m, e.g., DataReady, as indicated by block 602. In order to learn of the occurrence of this event (e.g., DataReady), the wire program object preferably registers with the trigger program object using an Event_Advise_Notification( ) method having the desired event as an argument. In response, the VScrollBar1 object notifies Wire2 whenever its DataReady event occurs. Alternatively, the event handler procedure may be initiated by invoking the wire's Run method, as indicated by block 604. Following initialization, the next step is to determine whether the wire program object's Enabled property 442d is TRUE, as indicated at block 606. If the wire's Enabled property 442d is FALSE, the code preferably ends, as indicated by first end block 608. As explained above, when the wire program object is first instantiated, it sets its Enabled property 442d to TRUE. Thus, unless the Enabled property 442d was subsequently set to FALSE at some point during run-time, as explained below, or was re-set by the developer, the response to decision block 606 is typically yes.

As indicated at block 610, the event handler procedure next retrieves the value of the property specified in the wire's Source property 442i, e.g., Value, from the source object, e.g., VscrollBar1, also identified in the wire's Source property 442i. To do this, a Get( ) method may be invoked on the source program object. A separate Get( ) method may be invoked for each readable property. The Get( ) method is a conventional method that is preferably supported by all of the component controls or program objects utilized by the program-development environment 310 of the present invention. As an argument to the Get( ) method, the code inserts the name of the property, e.g., Value, the value or setting of which is to be returned. Suppose the current setting of the VScrollBar1 's Value property is “15”. Then, in response to the Get( ) method, the VScrollBar1 returns “15” to the wire program object. This value may be returned to the wire program object through either a Pass_By_Value or Pass_By_Reference communication method, both of which are well-known to those skilled in the art. The wire program object next copies this value, i.e., “15” to its own Value property 422n, as indicated at block 612. Upon copying the value into its Value property, the wire program object preferably issues its Action event, as indicated at block 614. Other elements or processes of the application program, including other component controls or program objects, may register as “observers” with the wire program object using the Event_Advise_Notification method described above so as to be notified of the wire's Action event. These observers may respond to the wire's Action event in any number of ways. At decision block 616, the wire program object waits until all of these “observers” have indicated that they have finished processing the wire's Action event.

Next, the wire program object queries whether its Cancel property 442c (FIG. 4D) is FALSE, as indicated at block 618. As explained above, when the designer system 314 first sets the properties of a wire program object, it sets the Cancel property 442c to FALSE. In response to the wire's Action event (or some other event), however, another process, control component or program object may change the wire's Cancel property 442c from FALSE to TRUE. If the wire's Cancel property 442c is TRUE, then execution stops as indicated by second end block 620. Assuming the wire's Cancel property 442c is still FALSE, then the wire next up-dates the Sink property 442h, i.e., Caption, with the current value of its own Value property 442n, as indicated at block 622. This may be accomplished by invoking a Set( ) method on the sink control identified by the wire's Sink property 442h, i.e., Label1. A separate Set( ) method may also be invoked for each settable property. The Set( ) method is another conventional method supported by all of the component controls or program objects utilized in the program-development environment 310 of the present invention.

After setting the sink's property, the code corresponding to the wire program object issues a Done event, as indicated at block 624. Observers may similarly register with the wire program object, again using the above-described Event_Advise_Notification method, so as to be notified of its Done event. These observers may be configured to take any number of different actions in response to the wire's Done event. At this point, the wire program object has finished executing as indicated by third end block 626.

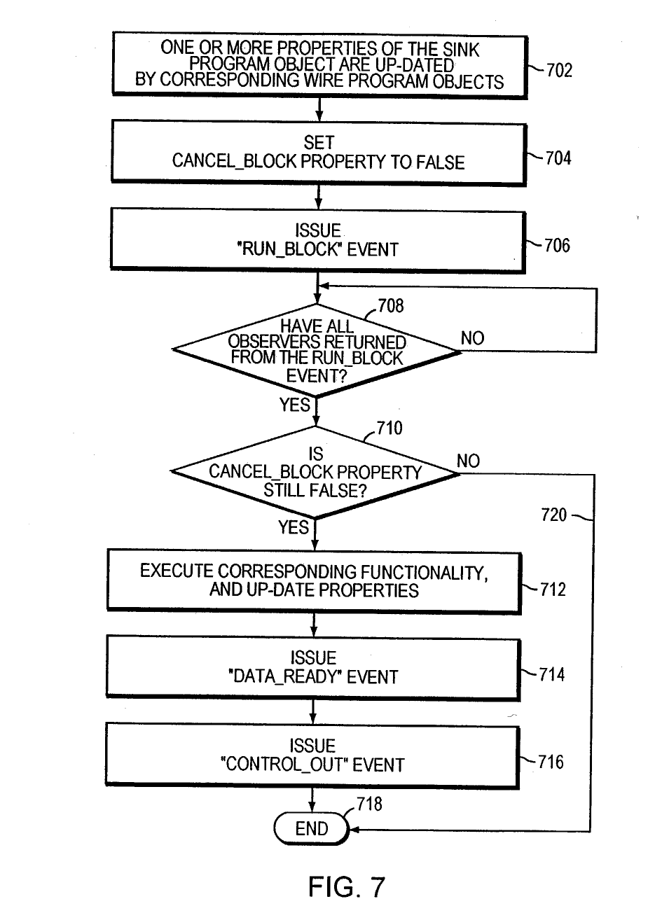

FIG. 7 is a flow diagram of steps preferably executed by a typical program object, such as the Label1 program object, incorporated in the application program being developed during application run-time. The program object begins execution in response to one or more of its properties being up-dated by a corresponding wire object as indicated at block 702, such as when the Wire2 object up-dates the Caption property of Label1. Next, the program object sets its CancelBlock property to FALSE as indicated at block 704. The program object then issues its RunBlock event as reflected at block 706. As with the Action and Done events issued by the wire program objects, observers (including wire program objects) may register with the program object using the Event_Advise_Notification mechanism so as to be notified of its RunBlock event. These observers may interact with the program object by, for example, changing its properties etc. As indicated by decision block 708, the program object waits until all such observers have returned from its RunBlock event.

Next, the program object determines whether its CancelBlock property is still FALSE as indicated at decision block 710. One or more of the observers could have set the program object's CancelBlock property to TRUE in response to processing the RunBlock event. If its CancelBlock property is still FALSE, the program object executes its corresponding functionality and up-dates its own corresponding properties as warranted as indicated by block 712. Upon up-dating its properties, the program object issues its DataReady event as indicated by block 714. To the extent a wire program object is connected to one of this program object's data output terminals, the issuance or occurrence of the DataReady event may trigger that wire program object to begin operation. After issuing its DataReady event, the program object next issues its ControlOut event as indicated by block 716. To the extent the program object's control output terminal is connected to a wire construct, the corresponding wire may begin operation. Execution of the program object is now complete as reflected by End block 718. If, in response to decision block 710, the program object's CancelBlock property is TRUE, then processing stops at that point as indicated by No arrow 720 leading from decision block 710 to End block 718.

It should be understood that a given program object may execute its corresponding functionality, as described at step 712, and then issue a RunBlock event, as described at step 706. This may be implemented by objects that perform mathematical operations, for example, and are thus less likely to cause erroneous data propagation problems in the corresponding application program. It should be further understood that, depending on the type of program object, other events besides DataReady may be issued. For example, program objects that operate in discrete or determinative modes or states, such as the For Loop, Do Loop and Wait objects, described below, or an Analog In Scan object, may issue one or more StatusReady events in place of the DataReady event. Program objects that perform scanning functions, such as Analog In Scan or Analog Out Scan, may issue a RateReady event in place of the DataReady event. Those skilled in the art, moreover, will recognize that other such events may be defined and implemented by the program objects utilized with the program-development environment 310.

Generation of Event-Handler Code Through Textual Inputs

A significant advantage of the present invention is its ability also to generate event handler procedures or code in response to textual inputs by the developer. In some circumstances, for example, it may be more efficient to specify an event handler textually rather than graphically. In particular, following the example of FIGS. 4A-D, suppose the developer wishes to have the background color of the label image 438 turn red during run-time whenever the value to be displayed exceeds 15000. Although the label object has a BackColor property, in the absence of a specific terminal on the corresponding symbolic representation 434 for the Label1 program object that is associated with this property, it would be difficult to specify this functionality graphically. Indeed, with the prior art graphical program languages, such as HP VEE and LabVIEW, it would be extremely difficult, if not impossible, to provide this functionality, because the graphical images for the label program object provided by these prior art systems do not have a terminal or pin for setting the object's background color in response to the value of its Caption property.

With the present invention, the program-development environment 310 allows the developer to switch to a textual programming paradigm in order to specify an event procedure or other functionality that is more easily described textually as opposed to graphically. To specify an event handler textually, the developer directs the program-development environment 310 to call-up and display a code window in which textual inputs may be entered by the developer. More specifically, the developer, using mouse 230, moves the cursor 240 (FIG. 2) over the symbol of interest, e.g., Label symbol 438 (FIG. 4D), as displayed in the designer window 406 and executes a double mouse click. Since the cursor 240 is over the designer window at the time of the mouse click, the operating system 302 (FIG. 3) preferably passes the respective windows event to the graphical designer system 314. In response, the designer system 314 issues a call to the visual programming system 312, via arrow 320, causing it to display a code window on GUI 400 (FIG. 4D).

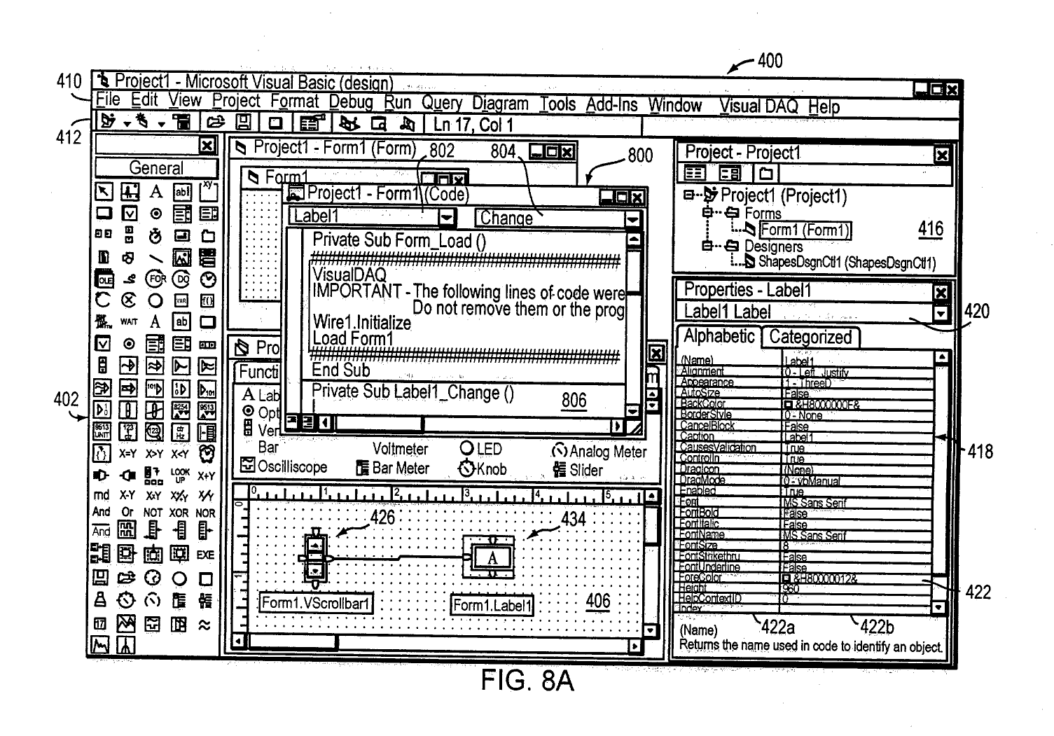

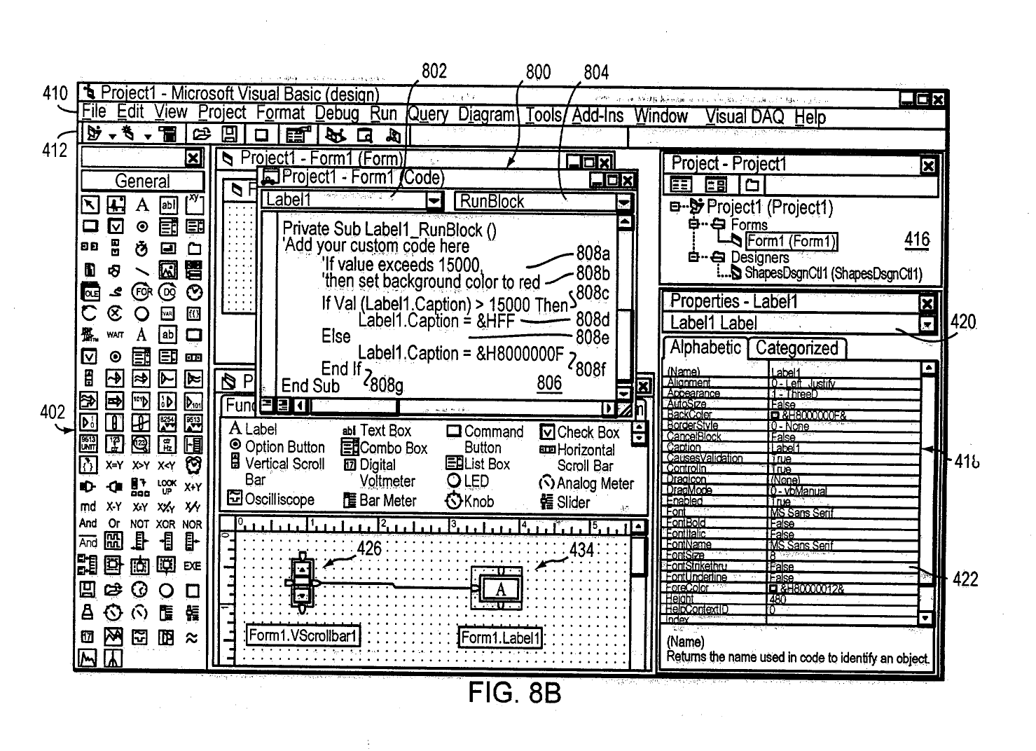

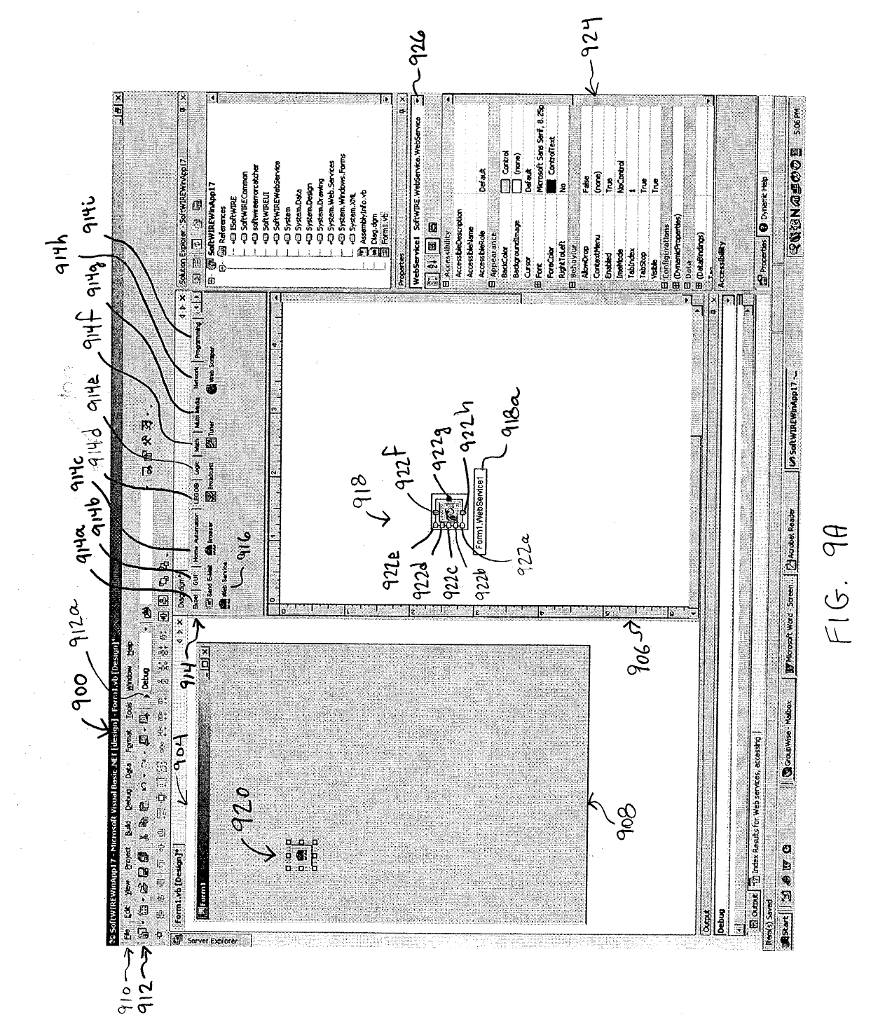

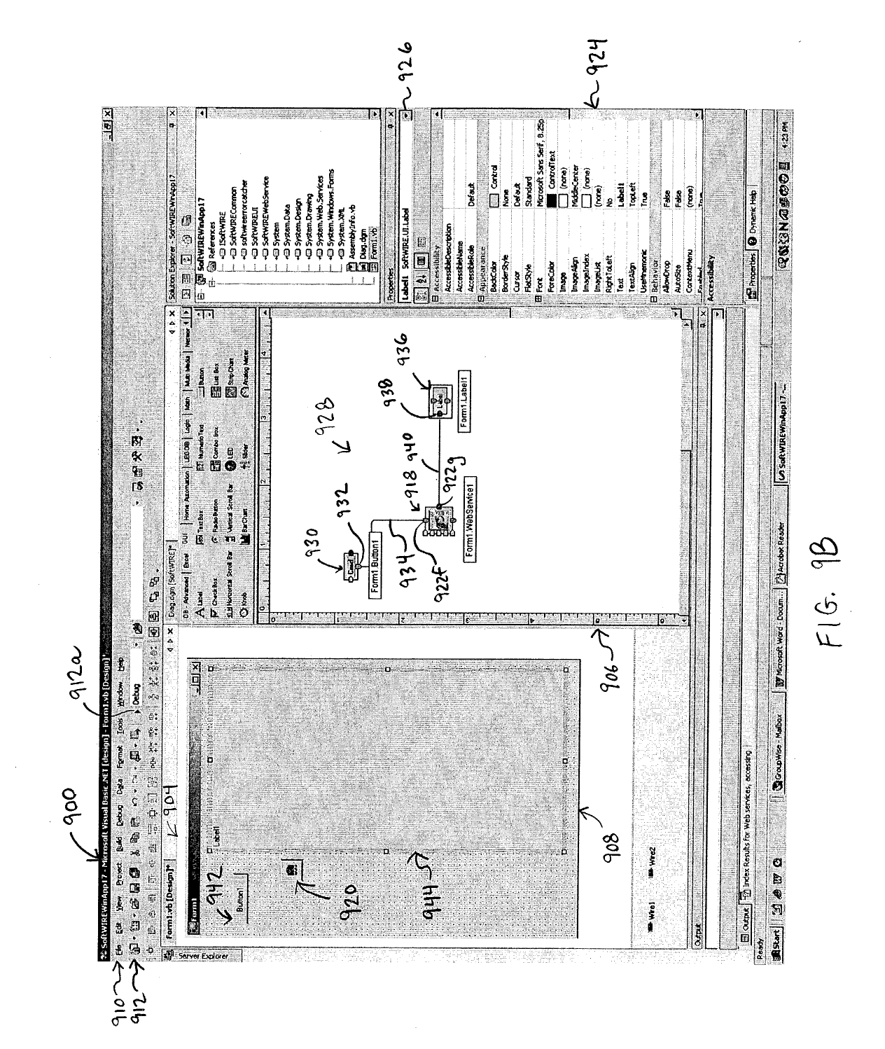

FIG. 8A is a preferred illustration of the GUI 400 of FIG. 4D further including a code window 800. Code window 800 includes a pull-down object box 802, which contains a list of all of the program objects currently residing in the form window 404. By default, the object box 802 initially displays the program object selected by the developer, e.g., Label1. Code window 800 further includes a pull-down procedures/events box 804, which contains a list of all of the procedures and events supported by the selected program object of object box 802. Selecting a particular procedure or event from box 804 positions the entry point for subsequent textual inputs at the first line of the respective procedure or event. The procedures/events box 804 may initially display the first event supported by the corresponding object, e.g., the Change event, which is issued when an object's Value property changes. Code window 800 further includes an input area 806. Within the input area 806, the developer can write, review and edit program code for the respective application program using the keyboard 224 to generate textual inputs. In the preferred embodiment, the developer enters one or more statements within input area 806. A statement is basically a syntactically complete unit that expresses some action, declaration or definition. A statement generally occupies a single line, although a first designated symbol, e.g., the colon (“:”), may be used to include more than one statement on a line, and a second designated symbol, e.g., the line-continuation character (“_”), may be used to continue a single logical line onto a second physical line.

FIG. 8B is a preferred representation of the GUI 400 after the developer has written a series of statements 808a-g into the input area 806 of the code window 800 following the selection of the RunBlock event from the procedures/events box 804. As indicated above, statements 808a-g comply with the keywords and syntax defined by the programming language supported by the visual programming system 312 of the program-development environment. In the illustrative embodiment, this programming language is Microsoft's Visual Basic. Statements 808c-g specify the functionality for turning the background color of the label image 438 red if its Caption property (which is set to the Value property of VScrollBar1) exceeds 15000. Statements 808a-b are simply comment statements that describe the functionality to be carried out by the subsequent statements.

In response to entering one or more statements in the input area 806 of code window 800, the program-development environment 310 generates constituent program code for insertion in the corresponding application program. That is, at run-time, the statements 808a-g are compiled or interpreted and executed as required, thereby implementing the functionality of the corresponding statements.

Those skilled in the art will understand that the code window 800 may be called-up in other ways. For example, the developer may choose the “Code” option (not shown) from the View command of menu bar 410.

It should be understood that a developer may also display and edit the properties of a wire program object, thereby causing the program-development environment 310 to modify the corresponding event handler procedure. As described above, the developer may cause the properties of a wire object, e.g., Wire2, to be displayed in the properties window 418 of GUI 400. By selecting one of the properties listed in the property window 422 of window 418, typically through a mouse click, the developer can edit the selected property. For example, although the wire program object preferably sets its Beep property 442b to FALSE upon instantiation, the developer may re-set this property to TRUE through textual inputs entered in the property window 418. In response, the event-handler procedure generated by the program-development environment 310 causes the computer system 200 to sound a tone each time the wire program object executes.

The developer may also change a given wire object's trigger property 442m to a different event and/or a different program object. More specifically, as described above, the program-development environment 310 sets the trigger property 442m of a wire program object based on the particular source terminal, e.g., terminal 430c, to which the wire construct 440 of the corresponding wire program object, e.g., Wire2, is connected. The wire program object, moreover, executes in response to the occurrence of the event specified in its trigger property 442m. By editing the trigger property 442m, a developer may cause the program-development environment 310 to modify the corresponding event handler procedure such that the wire program object now executes in response to some newly identified event and/or program object (e.g., an object other than the wire's source object). To prevent developer-induced errors, the program-development environment 310 may be configured to block the display (and thus the editing) of wire program object properties through property window 418.

Although the program development environment 310 of the present invention involves graphical event handler code generation, some implementations may not provide that capability for all available control components or program objects that may be incorporated into a given application program. Or, they may provide different toolbox icons or elements for the same control components, some of which enable the developer to program the control's event handlers graphically and others that do not. In such implementations, the toolbox 402 (FIG. 4A) may be divided into two areas. A first area 402a contains a plurality of icons corresponding to program object classes that can only be used in the form window 404. The program objects corresponding to these icons do not have a corresponding symbolic representation for use in the designer window 406. A second area 402b contains a plurality of icons that can be used in both the form window 404 and the designer window 406. That is, the program objects corresponding to these icons include symbolic representations capable of display in the designer window 406.

It should be understood that program objects need not include all of the above-specified properties or events. For example, program objects may not have an InvalidProperty property or a StatusReady event. Furthermore, rather than a single RunBlock event, program objects may have a PreRunBlock event, which occurs when the program object has latched its input properties and is ready to perform its primary function, and a PostRunBlock event, which occurs after the program object has executed its primary function and is ready to update its output property(ies). In addition, various of the properties, methods and events may be given different names.

The wire controls may also be defined without all of the above-identified properties, methods or events. For example, the wire controls may be without index, left, right or tag properties. Furthermore, rather than including the property of the sink object in the wire control's Sink property, a new property, known as the SinkProperty, may be provided, which corresponds to the name of the sink program object's respective property to which the wire control is graphically connected. Similarly, rather than include the source property as part of the wire control's Source property, a new property, known as the SourceProperty, may be provided, which corresponds to the name of the source program object's respective property to which the wire control is graphically connected. Those skilled in the art will recognize that other changes may also be made.

Web Service Control

According to the present invention, the program-development environment 310 (FIG. 3) is further configured to incorporate program code within the application program being developed that facilitates the consumption of web services during application run-time. In particular, as described below, the program-development environment 310 includes a web service control or program object that can be instantiated one or more times and placed onto a program development form. The web service program object may be represented by a corresponding icon that may be caused to appear in the designer window 406 of the GUI 400. Each web service icon within the designer window 406 also has a web service user interface element in the user form program object window 408. The icon representing the web service program object may be connected to other icons within the designer window 406 using one or more wire constructs in order construct a desired application program that accesses the specified web service and utilizes the results or other information therefrom.

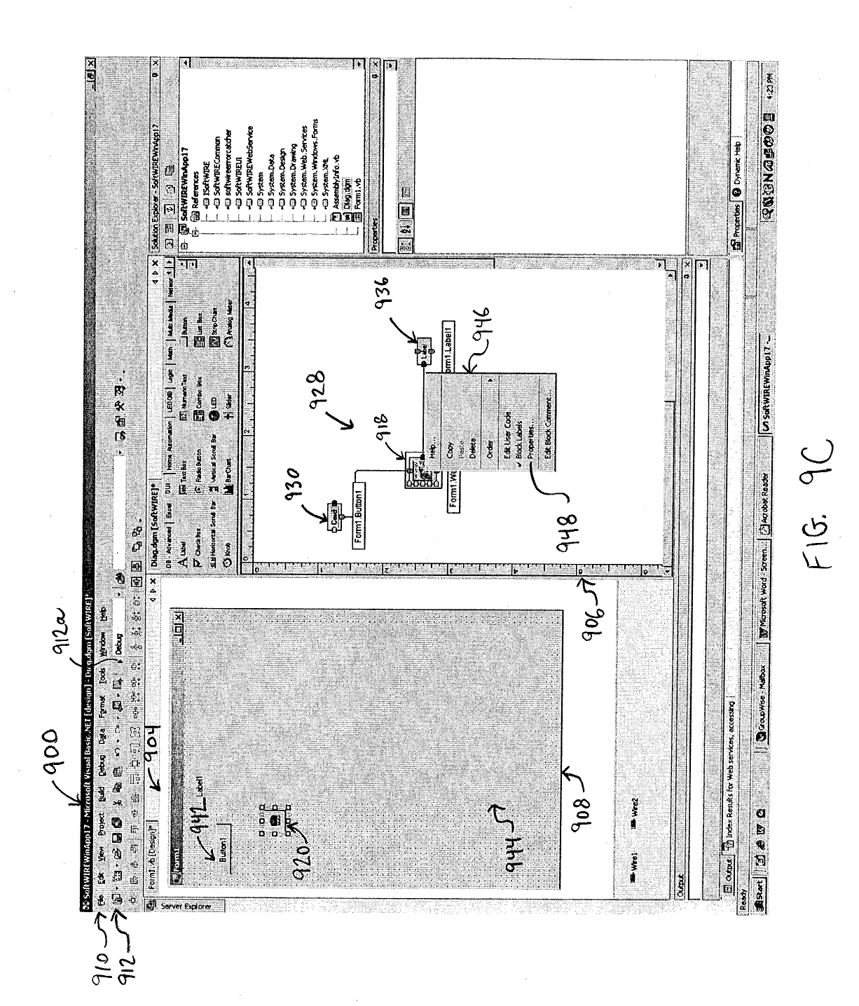

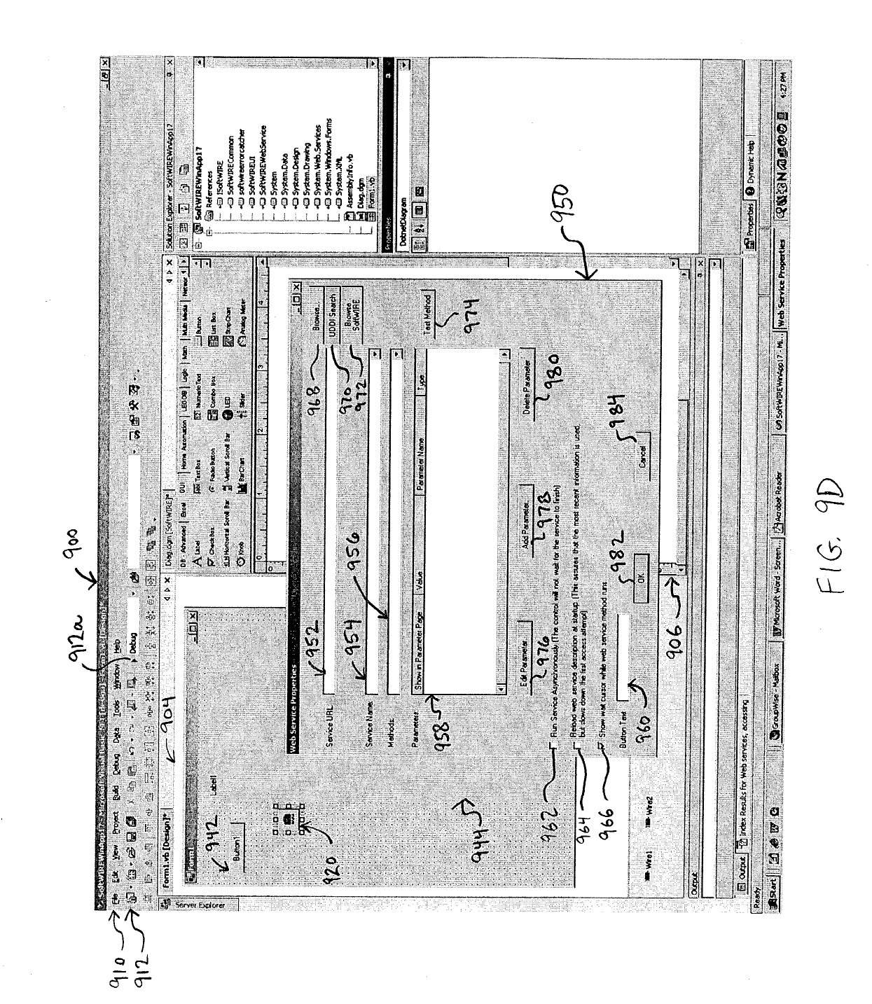

The use and operation of the web service control of the present invention may best be understood through an example. FIGS. 9A-E are preferred representations of a program development GUI that has been manipulated to include a two-dimensional, graphical representation of an application program that incorporates a web service icon. FIGS. 9A-E are preferred representations of a GUI 900 generated by the program-development environment 310 (FIG. 3) on computer screen 235 similar to GUI 400 (FIG. 4A) described above. Like GUI 400, GUI 900 also has several elements including one or more form windows 904 and a diagrammer or designer window 906. The form window 904 includes a user form program object 908, which provides an image of the user interface being developed for the application program. The GUI 900 may further include a menu bar 910 with a plurality of pull-down menu items and a toolbar 912 that contains a plurality of buttons providing short-cuts to commonly used tasks or functions, including a play or run button 912a. The designer window 906 also includes its own toolbar 914, which may be divided into a plurality of sub-toolbars, such as sub-toolbars 914a-i, each having a corresponding tab that may be labeled (e.g., Excel, GUI, Home Automation, LEGO®, Logic, Math, Multimedia, Network and Programming). Disposed on each sub-toolbar 914a-i are one or more pictorial representations. Each pictorial representation corresponds to a control or program object class, and selection of a pictorial representation (e.g., through a mouse click) causes an instantiation of the control or program object to be placed in a form and further causes an icon to appear in at least the designer window 906. Included on the Network sub-toolbar 914h is a Web Service representation 916, among others.

In response to the program developer's selecting the Web Service pictorial representation 916 from the Network sub-toolbar 914h, the graphical designer system 314 causes an icon 918 of the program object corresponding to the Web Service class to be displayed in the diagrammer window 906. The designer system 314 also issues a call to the visual programming system 312 directing the visual programming system 312 to instantiate a program object from the Web Service class and add that program object to the container application represented by the form window 904. In the illustrative embodiment, the visual programming system 312 also causes a web service user interface symbol 920 to appear in the user form object 908. Web Service symbol 920 basically corresponds to the way in which the web service user element will appear in the respective user interface at run-time of the application program being created. Web Service symbol 920 may be moved and/or re-sized by the developer in a conventional manner.

As part of the process of adding a program object to the form window 904, the visual programming system 312 also assigns a name to that program object. The name may consist of the object's class followed by an integer, e.g., WebService1 for the first web service control to be added to form window 904. The name uniquely identifies the program object within the form 904. Upon adding the program object to the form window 904, the visual programming system 312 preferably returns the assigned name to designer system 314 by a communication mechanism represented by arrow 318. The program-development environment 310 may then display a name 918a as part of the icon 918 within the diagrammer window 906. The name displayed in diagrammer window 906, e.g., Form1.WebService1, may be derived by concatenating the name of the program object, e.g., WebService1, with the name of the form window in which it resides, e.g., Form1.

The Web Service program object of the present invention preferably has a plurality of predefined properties, methods and events many of which are declared to be public and may thus be set or accessed by the program developer. In particular, the properties of the web service program object include: AddParameter, ButtonText, ClearParameters, Method, ParameterArray, ParameterName, ParameterValue, ReloadDescription, RunAsynchronously, Service, ShowParameterPage, ShowWaitCursor, UniformResourceLocator (URL), Value and ControlIn. The method associated with the Web Service program object is Operate. The events associated with the Web Service program object include PreRunBlock, PostRunBlock, DataReady, ControlIn, ControlOut, etc. The Web Service icon 918 preferably has a plurality of, e.g., eight, pins or terminals 922a-h, each of which is associated with a pre-defined combination of the properties, methods and/or events of the respective Web Service program object that is symbolically represented by icon 918. Specifically, terminal 922a is associated with the web service program object's ShowParameterPage property. Terminal 922b is associated with the web service program object's ClearParameters property. Terminal 922c is associated with the web service program object's AddParameter property. Terminal 922d is associated with the web service program object's ParameterValue property. Terminal 922e is associated with the web service program object's ParameterName property. Terminal 922f is associated with the web service program object's ControlIn property. Terminal 922g is associated with the web service program object's Value property and its DataReady event. Terminal 922h is associated with the web service program object's ControlOut event.

The properties (or at least those properties that are declared public and may thus be changed by the program developer) of the web service program object may each be selectively displayed by the program-development environment 310 (FIG. 3) in a properties window 924 by selecting the desired object from a pull-down object list 926. The specific properties displayed within the corresponding properties window 924, moreover, may be modified and edited by the developer, thereby changing the properties of the respective program object residing in the form window 904.

FIG. 9B shows a graphical representation 928 of a program that was created within the diagrammer window 906 by a program developer. Graphical representation 928 includes, in addition to the web service icon 918, a command button icon 930 that has a control out terminal 932 that is coupled via a first wire construct 934 to the control in terminal 922f of the web service icon 918. Graphical representation 928 further includes a label icon 936 that has an input terminal 938 that is coupled via a second wire construct 940 to output terminal 922g of the web service icon 918. As the web service icon 918, command button icon 930 and label icon 936 are all user interface elements, companion symbolic representations 920, 942 and 944, respectively, are displayed in the form window 904.

To edit a program object's properties, such as the web service program object represented by icon 918, the program developer may display the selected program object's properties in the properties window 924 (FIG. 9B) as described above. The program-development environment 310 also supports at least one or more additional ways of editing a program object's properties. In particular, as shown in FIG. 9C, when the program developer executes a “right mouse click” on a selected icon, such as the web service icon 920 within designer window 906, the program-development environment 310 causes a command pop-up menu 946 to appear. Command window 946 displays a series of commands that may be performed on the program object of the selected icon, e.g., on the web service program object corresponding to icon 918. The commands include Help, Copy, Paste, Delete, Order, Edit User Code, Block labels, Properties 948 and Edit Block Comment.

As shown in FIG. 9D, by selecting (e.g., clicking) the properties command 948 (FIG. 9C), the program developer causes the program development environment 310 to display a properties page dialog window 950 for the web service program object corresponding to icon 918. This properties page dialog window 950 includes a plurality of entry fields, check boxes and command buttons. Specifically, window 950 includes a Service URL field 952, a Service Name field 954, a Methods field 956, a Parameters list box 958, and a Button Text field 960, each of which receive information as directed by the program developer as described herein. Window 950 further includes a Run Service Asynchronously check box 962, a Reload Web Service Description at Startup check box 964, and a Show Wait Cursor While Web Service Method Runs check box 966, each of which may be checked or unchecked by the program developer. In addition, Window 950 has a Browse button 968, a Universal Description, Discovery and Integration Service (UDDI) Search button 970, a Browse SoftWIRE button 972, a Test Method button 974, an Edit Parameter button 976, an Add Parameter button 978, a Delete Parameter button 980, an okay (OK) button 982 and a Cancel button 984, each of which may be “pressed” by the program user to cause a response from the web service program object and/or the program development environment as described herein.

As described herein, the program user enters information into window 950 to specify the particular web service that is to be consumed by the web service program object represented by icon 918. In particular, the program user enters the network address, e.g., the URL, of the web service in the Service URL field 952. Buttons 968, 970 and 972 help the user identify the desired URL. Specifically, by pressing Browse button 968, the program developer causes the program development environment 310 to open an Internet browser application (not shown), such as Internet Explorer from Microsoft, to be opened with the URL that was entered in field 952. In this way, the program developer can examine the web service that is to be consumed. When the program developer closes the browser application, the current URL is entered into the Service URL field 952 of window 950. If the program developer presses the UDDI Search button 970, the browser application is opened to a UDDI site, such as Microsoft's UDDI site, i.e., http://uddi.microsoft.com/, which allows the program developer to search for a desired web service, e.g., by offering company name. If the program developer presses the Browse SoftWIRE button 972, the browser application is opened to a website listing a plurality of available web services, such as http://www.softwire.com/webservices.html, which is a web site maintained by the owner of the present application that contains a list of web services. The program user can then select a desired web service from this list.

Those skilled in the art will recognize that the web service program object of the present invention may be configured to cause the browser application to access other UDDI or web sites in response to selection of the UDDI Search button 970 and/or the Browse SoftWIRE button 972.

FIG. 9E is a highly schematic illustration of GUI 900 in which the program developer has entered selected information into window 950. Specifically, the program developer entered the following URL into the Service URL field 952:

http://weather.unisysfsp.com/PDCWebService/WeatherService.asmx

Upon entering the URL of the desired web service in the Service URL field 952, the program developer preferably enters the name of the desired service in the Service Name field 954, e.g., WeatherServices. That is, a web service located at a given network address may provide multiple services each having a different name, any one of which may be accessed and consumed. In the illustrated embodiment, associated with the Service Name field 954 is a drop down button or arrow 954a. If the program user selects is the drop down button 954a, the web service program object causes the URL that was entered into field 952 to be accessed and the description associated with web service at that URL to be downloaded transparently to the program developer, e.g., without further input from the program developer. More specifically, the web service program object preferably includes web service access logic that utilizes the network connection at the program developer's computer to access the description of the web service and, in the preferred embodiment, to download that description to the program developer's computer. The description is preferably in a known format, such as the Web Service Description Language (WSDL), and the web service program object is configured to recognize information in this format.

The program object parses the downloaded description to extract the names of the available web services at the URL. In particular, the web service program object further includes description-parsing logic that examines the retrieved web service description, and pulls out the web services identified therein. The names of these available web services are then displayed to the program developer for selection. In the illustrative embodiment, they are loaded automatically into a drop down area (not shown) which appears below the Service Name field 954 upon selecting drop down button 954a. By selecting, e.g., with a mouse click, one of these service names, e.g., WeatherServices, it is automatically entered into the Service Name field 954.

The web service program object of the present invention can thus cause the services that are available at a given URL to be displayed automatically to the program developer for selection. This capability simplifies and greatly facilitates the consumption of web services. It also avoids the introduction of errors, such as misspellings, in entering the web service name.

The Methods field 956 similarly includes a drop down button or arrow 956a. Upon selection of arrow 956a, the description parsing logic of the web service program object parses the description obtained from the URL entered into field 952 and identifies the methods associated with the web service name that was entered into or selected for display within Service Name field 954. The identified methods are then automatically displayed in a drop down area (not shown) which appears below the Methods field 956. The program developer can then select one of these displayed methods, e.g., WeatherServiceSoap:GetWeatherText, for entry into the Methods field 956. Upon entry of the selected method into the Methods field 956, the description parsing logic of the web service program object identifies the parameters associated with the selected method, which are contained in the description, which are then individually listed on separate lines within the Parameters list box 958.

Each parameter typically has a plurality of characteristics and, in the illustrative embodiment, the Parameter list box 958 has a plurality of headings, including a “Show in Parameter Page” heading 958a, a Value heading 958b, a “Parameter Name” heading 958c and a Type heading 958d, each of which corresponds to a characteristic of the parameters. The corresponding characteristics for each parameter listed in box 958 appear under the respective heading. The entire list, moreover, constitutes a parameter array. For example, the WeatherServiceSoap:GetWeatherText method has a single parameter whose name is ZipCode. The ZipCode parameter has a Show in Parameter Page value of TRUE and is of the type “s:string”. The ZipCode parameter does not have a current or default value, as indicated in the blank space below the Value heading 958b. If the WeatherServiceSoap:GetWeatherText method had other parameters associated with it, they would appear in their own lines within Parameter list box 958. To edit a parameter in the list box 958, the program developer preferably highlights the entry of the parameter to be edited and presses the Edit Parameter button 976. In response, a dialog window (not shown) preferably appears on the display screen 235 (FIG. 2) having a field for each characteristic of the parameter that can be edited. To add a new parameter, the program developer presses the Add Parameter button 978. In response, a dialog window (not shown) appears having a field for each characteristic of the parameter that can be specified. To delete a parameter, the program developer preferably highlights the parameter to be deleted in the list box 958 and presses the Delete Parameter button 980.

Once a method has been selected and entered into the Methods field 956, the program developer may test that method by pressing the Test Method button 974. In response, the web service program object creates a proxy web service class at the program developer's computer. Specifically, the web service program object preferably includes a web service proxy class generator that creates the proxy class based, at least in part, on the description of the web service. The proxy class sends the input parameter values to the web service and looks for a response from the web service. If the web service responds as expected, a popup window may appear indicating that the web service method tested successfully.

If the selected web service will take a long time to run, the program developer may check the Run Service Asynchronously box 962. By checking box 962, the program developer sets the web service program object's RunAsynchronously property to TRUE. When a web service program object's RunAsynchronously property is TRUE, the object will not wait for the web service to complete before firing its ControlOut event at application run-time. The time taken for the web service to run will thus not delay the rest of the application program that was created. When the web service finishes its operation, the web service program object will update its Value property with the value received from the web service, and fire its DataReady event. The default value of a web service program object's RunAsynchronously property is preferably FALSE.

By checking the Reload web service description check box 964, the program developer sets the web service program object's ReloadDescription property to TRUE. When a program object's ReloadDescription property is TRUE, the service description for the respective web service will be reloaded by the web service program object at startup of the application program by the program user. This condition ensures that the most recent web service description information is used by the web service program object. It does, nonetheless, typically result in slowing down the first access to the web service during run-time of the application program. In the preferred embodiment, the default-value of a web service program object's ReloadDescription property is FALSE.

By checking the Show wait cursor check box 966, the program developer sets the web service program object's ShowWaitCursor property to TRUE. When a web service program object's ShowWaitCursor property is TRUE, the program objects causes the wait cursor to be shown on the display screen 235 at application run-time while the web service method runs. If the web service program object's ShowWaitCursor property is set to FALSE, then the wait cursor will not be shown on the display screen 235 while the web service method runs.

To label the web service user interface symbol 920 with some name or word, the program developer can enter the desired name or word in the Button Text field 960. By entering a value into field 960, the program developer sets the web service program object's ButtonText property to the entered value. The default value of a web service program object's ButtonText property is preferably null, e.g., “ ”.

Once the program developer has entered the appropriate information and settings into window 950, the program developer preferably presses the OK button 982. Pressing the OK button 982 causes the changes made in window 950 to be saved by the program development environment 310, and causes window 950 to disappear. To reject any changes that were made to the information or settings of window 950, the program developer presses the Cancel button 984. Once the web service program object has been configured in the desired manner, the application program can be run.

To run the application program corresponding to graphical representation 928 (FIG. 9B), a user can select the play or run button 912a. In response, the program development environment 310 generates and displays a run-time user input form.

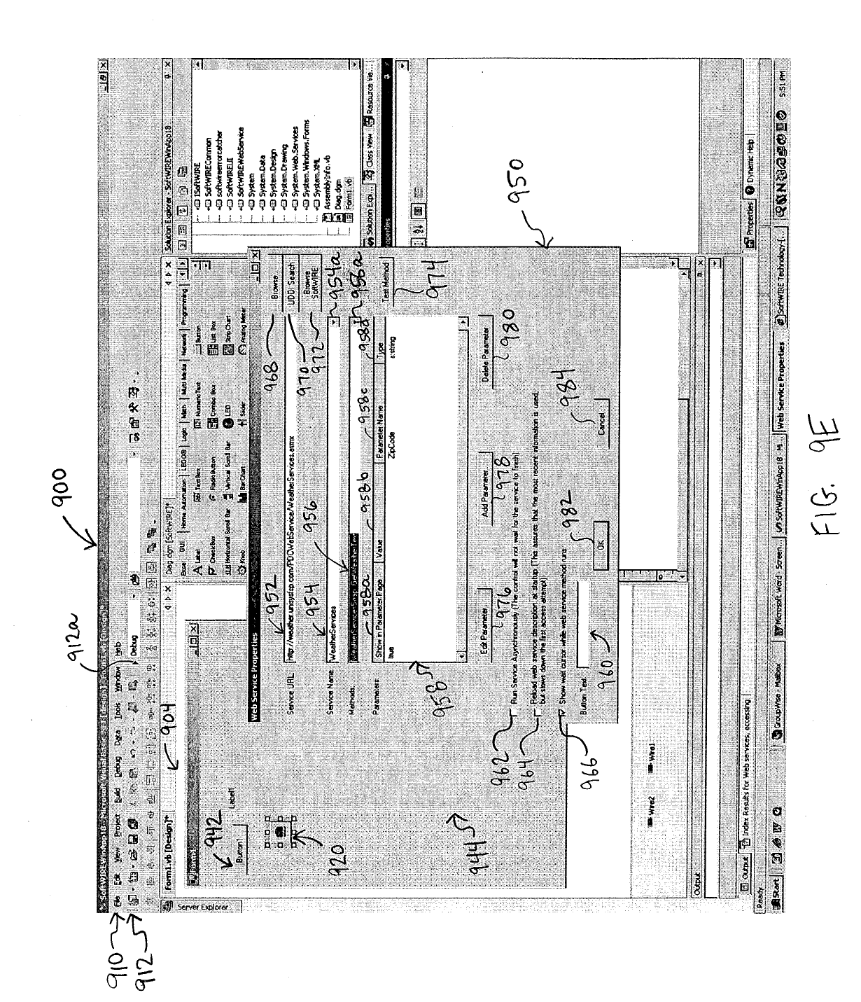

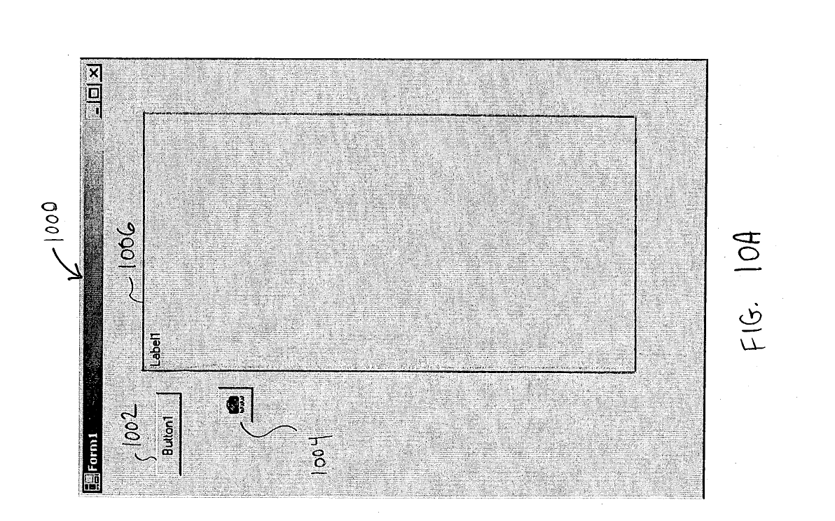

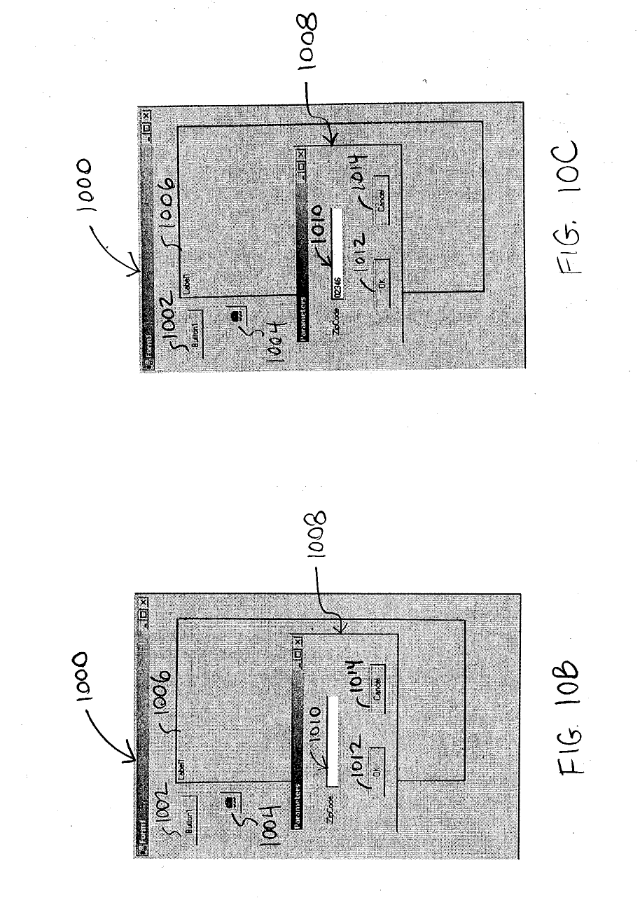

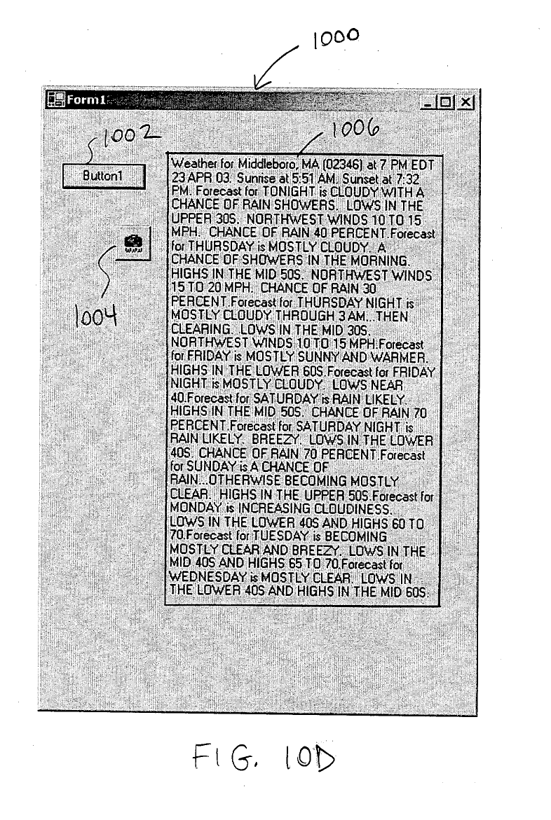

FIGS. 10A-D are highly schematic illustrations of a run-time form 1000 generated by the underlying program development utility, e.g., Visual Studio NET, for the program of graphical representation 928 (FIG. 9B). Referring to FIG. 10A, the run-time form 1000 has a user button element 1002, which corresponds to the symbolic representation 942 of the button program object that appeared in the form window 904. Run-time form 1000 further includes a user web service button element 1004, which corresponds to the symbolic representation 920 of the web service program object, and a user label element 1006, which corresponds to the symbolic representation 944 of the label program object. To use the program, the user preferably presses, e.g., selects with the mouse, the user web service element 1004 appearing on the run-time form 1000.

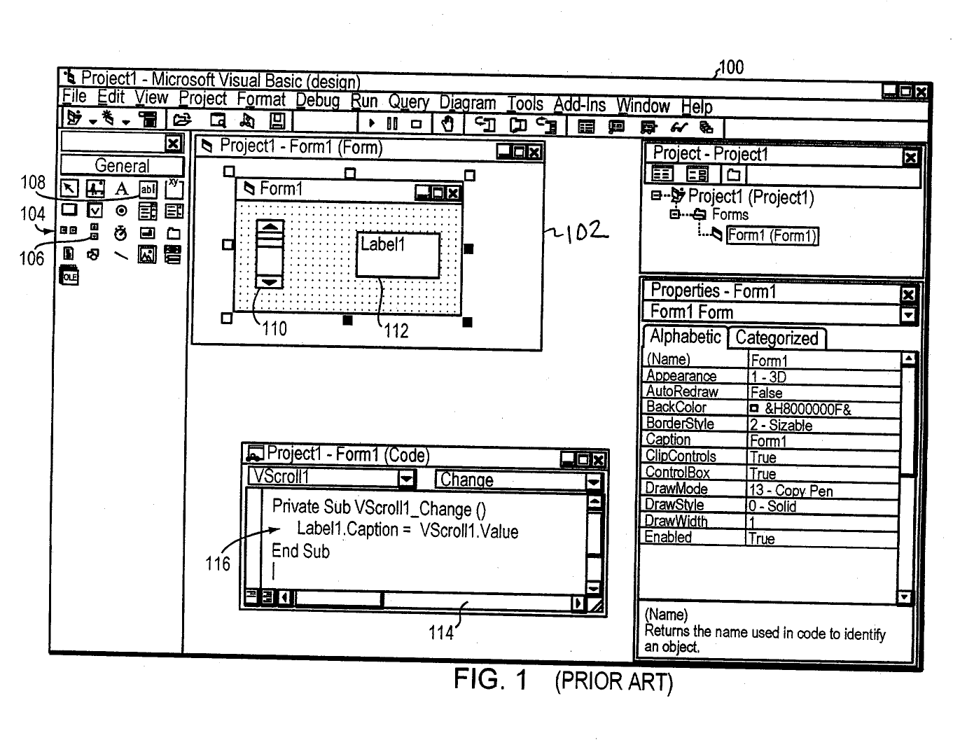

By pressing web service element 1004, the program user causes the web service program object to determine which input parameters it needs to submit to the web service. The web service program object preferably examines its ParameterArray property to make this determination. In this case, the only input parameter needed by the web service program object is the ZipCode parameter, which is in the form of a string. To obtain the input parameter from the program user, the web service program object preferably causes a parameter entry page 1008 (FIG. 10B) to be displayed on screen 242, which prompts the program user to enter or change the input parameters that are to be sent to the web service. In this example, the parameter entry page 1008 includes a ZipCode field 1010 that displays a default zip code value, if any, that can be changed by the program user. Here, no default value for the zip code was entered by the program developer. Accordingly, the ZipCode field 1010 is empty. The parameter entry page 1008 further includes an Okay (OK) button 1012 and a Cancel button 1014. The program user preferably enters the zip code, e.g., 02346, of the location for which textual weather information is desired into the ZipCode field 1010 of the parameter entry page 1008 as indicated in FIG. 1C. The program user then presses the OK button 1014. The web service program object receives the inputted value, i.e., 02346, and sets its ParameterValue property that is associated with the ZipCode parameter to the inputted value.

After entering the zip code, e.g., 02346, the program user preferably presses the pressing OK button 1012. In response, the web service program object causes the parameter entry page 1008 to disappear. Because the web service program object's control in terminal 922f (FIG. 9B) has been wired, i.e., to the command button program object corresponding to icon 930, the web service program object waits to receive a new value for its ControlIn property before accessing the designated web service. When the program user next button 1002 on run-time form 1000, the button program object responds by updating its Value property and firing its DataReady event. This causes the first wire construct 934 (FIG. 9B) to get the new value of the button program object's Value property, and set the web service program object's ControlIn property to this new value. Now that the web service program object's ControlIn property has been set, it can proceed to access the designated web service.

Specifically, the web service program object creates a proxy web service class (assuming it was not previously created) at the program user's computer for communicating with the specified web service. The proxy class is preferably created as a compiled dynamic link library (DLL) using the CSharpCodeProvider and the CodeGenerator components of the visual programming system 312 (FIG. 3), e.g., Microsoft's Visual Studio .NET. The name of the DLL is created by appending “Proxy.dll” to a portion of the URL. In the present example, the DLL name may be “weatherRetriever.asmxProxy.dll”. The proxy class, in turn, utilizes the System.Web.Services.Protocols.SoapHttpClientProtocol class, as provided by the visual programming system 312, to communicate with the designated web service. Communication is preferably accomplished with the XML and HTTP protocols.

In the illustrated embodiment, the web service program object first attempts to create the proxy class in the computer's main memory to improve performance in running the application program. If main memory lacks sufficient space for the proxy class or the web service contains non-standard objects or objects that cannot be serialized, the web service program object stores the proxy class on the computer's hard disk, e.g., in the application program's directory.

Upon creating the proxy class, the web service program object in cooperation with the proxy class passes the input value to the web service. Specifically, the web service program object and the proxy class cooperate to form one or more SOAP messages that carry the input value encoded in XML format as specified by the description for the web service. The web service receives the input parameter and performs its logic. In this case, the web service obtains a textual weather report for the area corresponding to the received zip code value. Suppose that the textual weather information generated by the web service is as follows:

Weather for Middleboro, Mass. (02346) at 7 PM EDT Apr. 23, 2003. Sunrise at 5:51 AM. Sunset at 7:32 PM. Forecast for TONIGHT is CLOUDY WITH A CHANCE OF RAIN SHOWERS. LOWS IN THE UPPER 30S. NORTHWEST WINDS 10 TO 15 MPH. CHANCE OF RAIN 40 PERCENT. Forecast for THURSDAY is MOSTLY CLOUDY. A CHANCE OF SHOWERS IN THE MORNING HIGHS IN THE MID 50S. NORTHWEST WINDS 15 TO 20 MPH. CHANCE OF RAIN 30 PERCENT. Forecast for THURSDAY NIGHT is MOSTLY CLOUDY THROUGH 3 AM . . . THEN CLEARING. LOWS IN THE MID 30S. NORTHWEST WINDS 10 TO 15 MPH. Forecast for FRIDAY is MOSTLY SUNNY AND WARMER. HIGHS IN THE LOWER 60S. Forecast for FRIDAY NIGHT is MOSTLY CLOUDY. LOWS NEAR 40. Forecast for SATURDAY is RAIN LIKELY. HIGHS IN THE MID 50S. CHANCE OF RAIN 70 PERCENT. Forecast for SATURDAY NIGHT is RAIN LIKELY. BREEZY. LOWS IN THE LOWER 40S. CHANCE OF RAIN 70 PERCENT. Forecast for SUNDAY is A CHANCE OF RAIN . . . OTHERWISE BECOMING MOSTLY CLEAR. HIGHS IN THE UPPER 50S. Forecast for MONDAY is INCREASING CLOUDINESS. LOWS N THE LOWER 40S AND HIGHS 60 TO 70. Forecast for TUESDAY is BECOMING MOSTLY CLEAR AND BREEZY. LOWS IN THE MID 40S AND HIGHS 65 TO 70. Forecast for WEDNESDAY is MOSTLY CLEAR. LOWS IN THE LOWER 40S AND HIGHS IN THE MID 60S.

This textual weather report is then encoded in XML format, as specified by the web service's description, loaded into one or more SOAP messages and sent to the proxy class created at the program user's computer. The proxy class receives the one or more SOAP messages and, using the web service's description, decodes the XML formatted data and provides it to the web service program object. The web service program object sets its Value property to the weather text received from the proxy class, and fires its DataReady event.

In response to the web service program object's DataReady event, the second wire construct 940 gets the current value of the web service program object's Value property, i.e., the textual weather information returned from the web service, and sets the label program object's Value property to this new value. The label program object responds by causing the value of its Value property to be displayed in the user label element 1006 of the run-time form 1000 (FIG. 10D). The program user can thus view the textual weather information generated by the programmed web service for the area corresponding to the zip code value that was entered by the program user.

It should be understood that in other possibly more complex application programs, the input terminals of the web service icon 918 (FIG. 9A) may be connected by corresponding wire constructs to other icons representing other controls. For example, it is possible to add or specify input parameters to the web service program object at run-time. Specifically, a first icon, such as a text box, could be wired to the web service icon's “parameter name” input terminal 922e. The first text box may further be configured to supply a name of an input parameter to the web service program object at run-time. A second icon may be wired to the web service icon's “parameter value” input terminal 922d to supply a value for an input parameter. A third icon, such as a command button, could be wired to the web service icon's “add parameter” input terminal 922c. At run-time, the web service program object's ParameterName and ParameterValue properties will be updated with the values generated by the program objects corresponding to the first and second icons, which are wired to the web service icon's “parameter name” and “parameter value” input terminals 922e and 922d, respectively. When the web service program object's AddParameter property is updated with the value generated by the program object corresponding to the third icon, the web service program object responds by creating a new input parameter whose name corresponds to the object's ParameterName property and whose value corresponds to the object's ParamterValue property. If the parameter is already present in the parameter array of list box 958 (FIG. 9E), its value is replaced with the new value. If the ParameterName property is null, e.g., “ ”, the web service program object will determine the parameter name from the description of the web service.

It is also possible to clear the values of all input parameters by wiring up the “clear parameter” terminal 922b of the web service icon 918. In particular, a wire construct connected to the clear parameter terminal 922b will set the web service program object's ClearParameters property with the value received from the wire's source program object during run-time. When the web service program object's ClearParameters property is updated, it clears the values of the parameters identified in the list box 958. The ClearParameters property can thus be used to reset the web service program object.

Suppose, for example, that a web service that calculates future values requires three input parameters, e.g., Present Value, Annual Interest, and Annual Periods. When the web service program object's AddParameter property is set for the first time following the setting of the ClearParameters property, and the ParameterName property is null, the current value of the object's ParameterValue property is used to set the Present Value parameter. The next time the AddParameter property is set and the ParameterName is again null, the current value of the object's ParameterValue property is used to set the Annual Interest parameter. The third time the AddParameter property is set and the ParameterName is again null, the current value of the object's ParameterValue property is used to set the Annual Periods parameter. The web service program object now has all of the necessary input parameters and can provide them to the web service for processing.

In addition, rather than having the program user select or press the user web service button element 1004 to display the parameter entry page 1008, the program developer can wire the web service icon's show parameter page terminal 922a to some source object. When the wire updates the web service program object's ShowParameterPage property, the web service program object responds by causing the parameter entry page 1008 to be displayed to the program user. At this point the program user can enter or modify one or more of the parameters.

Significantly, the web service program object of the present invention can be configured so that a program user may change the web service's network address, the particular web service and/or the method that are accessed at run-time. This can be useful where the initially designated web service is unavailable, but the program user is aware of a substitute web service that can be used by the application program.

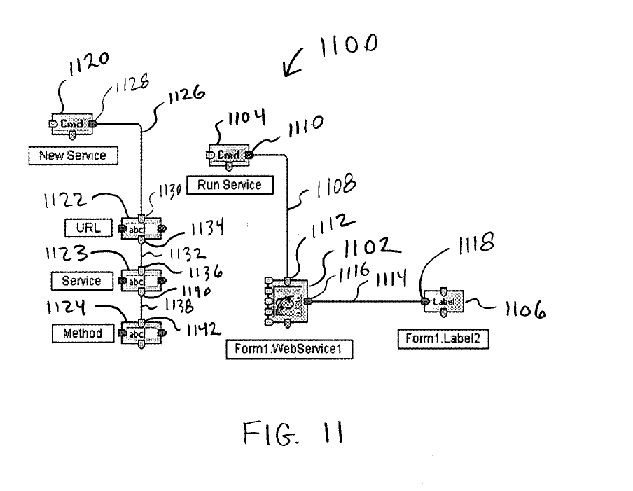

FIG. 11 is a highly schematic illustration of a graphical representation 1100 of an application program that allows a program user to change the network address, web service or method of the web service being accessed by the application program. The graphical representation 1100 includes a web service icon 1102, a first command button icon 1104, and a label icon 1106. As with graphical representation 928 (FIG. 9B), a first wire construct 1108 connects an output terminal 110 of the first command button to a control in terminal 1112 of the web service icon 1102. A second wire construct 1114 connects a data output terminal 1116 to a data input terminal 1118 of the label icon 1106.

The graphical representation 1100 further includes a second command button icon 1120 and first, second and third text box icons 1122-1124, which have been labeled “URL”, “Service” and “Method”, respectively. A third wire construct 1126 connects an output terminal 1128 of second command button icon 1120 to a control in terminal 1130 of the first text box icon 1122. A fourth wire construct 1132 connects a control out terminal 1134 of the first text box icon 1122 to a control in terminal 1136 of the second text box icon 1123. A fifth wire construct 1138 connects a control out terminal 1140 of the second text box icon 1123 to a control in terminal 1142 of the third text box icon 1124.

The program developer may then configure the properties of the web service program object corresponding to icon 1102 as described above in connection with FIG. 9E. That is, the program developer selects the network address, web service and method of a web service that provides local text-based weather information in response to a zip code.

As shown, neither the second command button icon nor any of the three text box icons 1122-1124 are connected either directly or indirectly to the web service icon 1102. To associate the information received by the program objects corresponding to the three text box icons 1122-1124 with the web service program object corresponding to icon 1102, the program developer preferably specifies the event handlers textually. More specifically, as described above, if the program developer double-clicks an icon, such as icon 1122, with the mouse, a code window (not shown) similar to code window 800 (FIG. 8A). The code window preferably includes an input area that is similar to input area 806 (FIG. 8A) for receiving textually defined code. In the illustrative embodiment, the program developer double-clicks each of the text box icons 1122-1124, and enters textual code that sets the web service program object's URL property to the value entered in the first text box 1112, that sets the web service program object's Service Property to the value entered in the second text box 1123, and that sets the web service program object's Method property to the value entered in the third text box 1124.

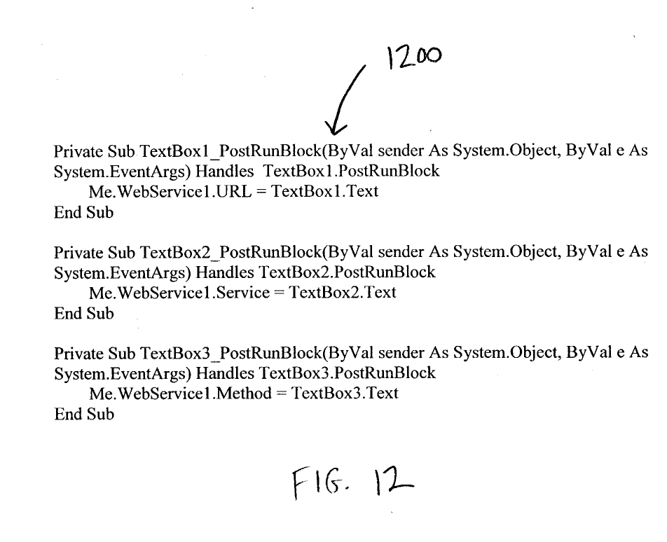

FIG. 12 is a highly schematic illustration of suitable textual code 1200 that may be entered into the input area of the code window to achieve the desired association of the text boxes with the web service program object.

When the application program corresponding to graphical representation 1100 is run, the program user preferably selects the web service button element (not shown) corresponding to web service icon 1102, and enters the input parameters, e.g., the zip code in the parameter entry page (not shown) that is displayed. The program user then presses the button element (not shown) corresponding to icon 1104. Now, suppose that the designated web service is unavailable, e.g., the server hosting the web service is down or the web service is no longer available. In this case, an error message may be displayed to the program user. In accordance with the present invention, the program user may specify a different web service, e.g., a different network location, a different service and/or a different method.

More specifically, the program user enters a network address, e.g., a URL, for a substitute web service in the text box element (not shown) corresponding to the first text box icon 1122. For example, the program user may be aware of a second web service having a different URL that similarly provides weather information in response to a zip code (or in response to some other input parameter). Next, the program user preferably enters the name of the substitute web service in the text box element corresponding to the second text box icon 1123. The program user then enters the name of the method of the selected substitute weather service that is to called into the text box element corresponding to the third text box icon 1124. After entering the information into the text box elements corresponding to icons 1122-1124, the program user preferably presses the command button element corresponding to the second command button icon 1120.

In response, the application program runs or executes the event handler code that was entered by the program developer textually within the input area of the code window at design time. This event handler code causes the URL, Service and Method properties of the web service program object corresponding to icon 1102 to be set with the values entered by the program user in the text box elements corresponding to text box icons 1122-1124. When the program user then presses the web service element corresponding to icon 1102, the web service program object preferably retrieves and examines the description of the substitute web service specified by the program user. The web service program object determines which input parameters are associated with method specified by the program user and causes a parameter entry page to be displayed requesting values from the program user for these parameters. Suppose that the substitute web service uses city and state information rather than zip code. In this case, the parameter entry page includes two input fields, one for the city and one for the state.

After entering the desired city and state information, the program user preferably the OK button of the parameter entry page. The program user then presses the command button element corresponding to icon 1104. In response, the web service program object creates a web service proxy class for the substitute web service that was specified by the program user in the text box elements corresponding to icons 1122-1124. The web service program object and the proxy class then cooperate to access the substitute web service, send it the input parameters specified by the program user and receive the resulting information or output data from the substitute. The output data from the web service program object is then provided to the label program object, which, in turn, causes the output data to be displayed in the label element (not shown) corresponding to icon 1106.

As shown, by declaring the URL, Service and Method properties of the web service program object to be public, the web service program object of the present invention can adjust the URL, service and/or method of the web service to be accessed dynamically during run-time in response to inputs from the program user.

It should be understood that the icon 1102 corresponding to the web service program object may be provided with additional terminals such as terminals associated with the object's URL, Service and Method properties. In this case, the three text box icons 1122-1124 could be wired directly to the these new input terminals of the web service icon 1102.

The foregoing description has been directed to specific embodiments of this invention. It will be apparent, however, that other variations and modifications may be made to the described embodiments, with the attainment of some or all of their advantages. For example, the default values of one or more of the web service program object's properties may be set to different values. Therefore, it is the object of the appended claims to cover all such variations and modifications as come within the true spirit and scope of the invention.

What is claimed is:

1. A web service program object for use with a graphical programming environment, the web service program object comprising:
a graphical icon representing the web service program object for display in a diagramming window of the graphical programming environment, the graphical icon having one or more terminals for visually linking the web service graphical icon with one or more other icons, each corresponding to a program object, to visually represent an application program in two-dimensions;
a first property that is settable by a program developer to define a network address of a given web service having a description that identifies one or more methods available from the given web service;
web service access logic configured to access and retrieve the description of the given web service; and
description parsing logic configured to extract the one or more methods identified in the retrieved description of the given web service, wherein
the one or more extracted methods are presented to a program developer for selection.

2. The web service program object of claim 1 further comprising a proxy web service class generator configured to generate a proxy class of the given web service, the proxy class configured and arranged to communicate with the given web service.

3. The web service program object of claim 2 further comprising:
a second property that is settable by the program developer to define a name of the given web service; and
a third property that is settable by the program developer to define a method of the given web service, wherein
one or more of the network address, web service name and method are changeable at run-time of the application program.

4. The web service program object of claim 3 wherein the terminals include a data output terminal for use in visually representing the graphical icon of the program object to receive a result produced by the given web service.

5. A method for creating an application that consumes a web service disposed at a network address, the web service having a method and configured to generate an output, the method comprising the steps of:
providing a diagrammer window for receiving a plurality of graphical icons, each graphical icon corresponding to a program object that executes a function;
providing a graphical web service icon for receipt on the diagrammer window, the web service graphical icon corresponding to a web service program object whose function is to consume the web service;
configuring the web service program object with the network address and the method of the web service; and
visually associating the graphical web service icon with a second graphical icon whose function receives the output of the web service, wherein
at application run-time, the web service program object accesses the web service, receives the output and causes the output to be provided to the program object corresponding to the second graphical icon.

6. The method of claim 5 wherein the web service has one or more input parameters from which the output is generated, the method further comprising the step of generating a parameter entry page at application run-time for receiving the one or more input parameters that are needed by the web service to generate the output.

7. The method of claim 6 further comprising the steps of:
sending the one or more received input parameters to the web service; and
receiving the output from the web service generated in response to the received input parameters.

8. The method of claim 5 wherein the web service has a plurality of methods, the method further comprising the steps of:
accessing a description of the web service, the description containing the plurality of methods;
parsing the description to identify the plurality of methods; and
presenting the plurality of methods to a program developer for selection.

9. The method of claim 8 wherein the web service has one or more input parameters associated with each method, the description further containing the input parameters, the method further comprising the steps of:
parsing the description to identify the one or more input parameters associated with the selected method; and
presenting the one or more input parameters associated with the selected method to the program developer.

10. The method of claim 5 further comprising the steps of:
generating a web service proxy class for interfacing with the web service at application run-time.

11. The method of claim 10 wherein the web service proxy class is created by the web service program object.

12. The method of claim 5 further comprising step of changing the network address of the web service at run-time.

13. The method of claim 12 further comprising the step of changing the web service method.
